(19) United States
(12) Patent Application Publication
(10) Pub. No.: US 2026/0247233 A1
(43) Pub. Date: Aug. 20, 2026

(54) MANAGING OR FACILITATING NETWORK CONNECTIVITY IN A WIRELESS COMMUNICATION SYSTEM

(71) Applicant: CANON KABUSHIKI KAISHA, Tokyo (JP)

(72) Inventors: Pascal LAGRANGE, Cesson-Sévigné (FR); Pierre VISA, Cesson-Sévigné (FR)

(21) Appl. No.: 19/472,039

(22) PCT Filed: Apr. 3, 2024
(86) PCT No.: PCT/EP2024/058992

§ 371 Date: Oct. 2, 2025

(30) Foreign Application Priority Data
Apr. 6, 2023 (GB) 2305177.4
Jul. 11, 2023 (GB) 2310632.1

(51) Int. Cl. H04W 36/00

(52) U.S. Cl. CPC H04W 36/00835

(57) ABSTRACT

Methods and apparatus for use in facilitating network connectivity of the wireless communication device in an Integrated Access and Backhaul, IAB, communication system are disclosed. A method at a wireless communication device comprises determining whether there are one or more preferred mobile cells other than a serving mobile cell serving the wireless communication device, the one or more preferred mobile cells being preferential target cells for the wireless communication device. In an example, the one or more preferred mobile cells are bound to each other and the wireless communication device may determine whether a serving cell, such as a serving mobile cell, serving the wireless communication device is bound to one or more other cells, such as one or more other mobile cells. For mobile cells, a cell may be bound to a mobile cell when movement of the cell is related to movement of the mobile cell. Methods at an IAB node associated with one or more cells, such as one or more mobile cells, of the IAB communication system and methods at an IAB donor node of the IAB communication system, the IAB donor node managing a connection between a wireless communication device and a serving cell, such as a serving mobile cell, serving the wireless communication device, are also disclosed.

### FIELD OF THE INVENTION

The present invention generally relates to managing or facilitating network connectivity in a wireless communication system. Particularly, the present invention relates to methods and apparatus for managing or facilitating network connectivity of a wireless communication device in an Integrated Access and Backhaul, IAB, communication system including, for example, at least one mobile Integrated Access and Backhaul, IAB, node.

### BACKGROUND

Wireless communication systems are largely deployed to address a wide range of applications, from mobile broadband, massive machine type communications to Ultra Reliable Low Latency Communications (URLLC). Such systems allow a plurality of user equipment (UE) or mobile terminals to share the wireless medium to exchange several types of data content (e.g., video, voice, messaging . . . ) over a radio access network (RAN) through one or more base stations. The base stations are conventionally wired-connected (e.g., through fiber) to a core network, forming an intermediate network, named backhaul (BH).

Examples of such wireless multiple-access communication systems include systems based on 3rd generation partnership project (3GPP-RTM) standards, such as fourth-generation (4G) Long Term Evolution (LTE) or recent fifth-generation (5G) New Radio (NR) systems, or systems based on IEEE 802.11 standards, such as WiFi.

The demand for network densification increases due to the rising number of users and higher throughput requirement.

Facing the issues of high deployment costs and time of the wired backhaul networks with network densification, 3GPP has proposed, in recent release 16 for 5G NR, a wireless backhaul, also known as Integrated Access and Backhaul, IAB, where part of the wireless (i.e. radio) spectrum is used for the backhaul connection of base stations instead of fiber. The wireless backhaul communications (between base stations) may use the same radio resources as access communications (between a base station and UEs).

IAB turns out to be a competitive alternative to the fiber-based backhauling in dense areas or areas difficult to cover, as it allows scalable and rapid installations without the burden of cabling the base stations.

IAB is most likely to operate in the millimeter wave (mmWave) band to achieve the required Gbps (gigabits per second) data rate.

Urban environments are usually characterised by a high density of users along with the presence of a significant number of vehicles (e.g. public/private passengers transportation, goods delivery, food trucks . . . ). The speed of some of the vehicles may be pretty low or at least similar to pedestrian speed and some of these vehicles may even be temporarily stationary. Some of these vehicles (e.g. buses, trains or trams), may have predictable routes and/or limited mobility areas (e.g. some vehicles, such as food trucks or promotional vehicles, may be located outside stadiums or show venues) while others may have predictable stationary locations (e.g. taxis).

3GPP is considering that such vehicles could offer an opportunity to increase network coverage and connectivity to the UEs inside the vehicles, or even to UEs in proximity to the vehicles, by installing on these vehicles on-board base stations (or base station elements) that would act as relays. These relays would rely on 5G wireless backhaul (typically IAB, or Integrated Access & Backhaul) for connecting to a fixed donor device, such as an IAB donor Central Unit (CU) directly connected to the core network. Thus, based upon the fixed IAB foundations set out in Releases 16 and 17, 3GPP is now considering Mobile IAB systems and architecture, as a part of the Release 18 framework, in order to address scenarios focusing on mobile IAB-nodes mounted on vehicles (for example, a bus, a train, a taxi). In such scenarios, mobile IAB-nodes can also be referred to as Vehicle Mounted Relays (VMR), providing 5G coverage/capacity to on-board and/or surrounding UEs. The technical benefits of using vehicle relays include, among others, the ability of the relay vehicle to get better coverage than the nearby UE, thanks to better RF/antenna capabilities, thus providing the UE with a better link to the macro network. Additionally, a vehicle relay is expected to have less stringent power/battery constraints than the UEs.

As a VMR or a mobile IAB (mIAB) node may be static at some point (e.g. taxi in a car park or at a taxi rank, bus in a car park or at a bus stop, train at a station, or temporary installation at an event or emergency/disaster case) while moving otherwise, the connection with mobile IAB (mIAB) nodes, or Vehicle Mounted Relays (VMR), is likely to fluctuate based on their actual movement. Therefore, in order to take benefit of the extra connectivity resulting from the presence of a mobile IAB node in the topology while mitigating the connectivity impact that may result from its actual mobility status, the connection of a network device, or User Equipment (UE), to the network via or through such a mobile IAB node should be managed carefully.

In this respect, in the context of mobile IAB, two kinds of UEs may be considered: 1) the surrounding UEs, referring to UEs connected to the mobile IAB node but which movement is not correlated to the mobile IAB node's movement (e.g. a smartphone used in the street nearby a bus station) and 2) on-board UEs (OB-UE), referring to UEs connected to the mobile IAB node and which movement is similar to the mobile IAB node's movement. An on-board UE is typically a UE that is located inside a vehicle on which is mounted a VMR or mobile IAB node (e.g. a smartphone used inside a bus or a train).

Moreover, for some long vehicles (e.g., trains), several mIAB nodes may be mounted on the vehicle and in such a case, the several mIAB nodes and their respective mobile cells will move together. Such mIAB nodes, and their respective mobile cells, may be referred to as bound mIAB nodes and bound mCells respectively.

Therefore, some new mechanisms are required to take benefit of the extra connectivity resulting from the presence of bound mobile cells in the topology, while limiting the complexity of the processing at an UE or an IAB-node or an IAB donor CU as well as the latency that would result from such processing.

### SUMMARY

In accordance with a first aspect of the present invention, there is provided a method, performed at a wireless communication device, for use in facilitating network connectivity of the wireless communication device in an Integrated Access and Backhaul, IAB, communication system, as recited in claim 1 of the accompanying claims.

The wireless communication device may be a User Equipment, UE, or a mobile IAB node.

In an example, the one or more preferred mobile cells are bound to each other. For mobile cells, a cell may be bound to a mobile cell when movement of the cell is related to movement of the mobile cell.

The determining may be based on measurements performed by the wireless communication device or based on information received by the wireless communication device, for example from an IAB node or from a IAB donor node. An advantage of the wireless communication device determining whether there are one or more preferred mobile cells other than a serving mobile cell or whether a serving mobile cell serving the wireless communication device is bound to one or more other mobile cells based on measurements performed by the wireless communication device is that the wireless communication device can autonomously determine bound cells. Making the determination based on information received from other nodes, does however mean that the processing required at the wireless communication device is reduced compared to the wireless communication device doing the determination.

In accordance with a second aspect of the present invention, there is provided a method for use in facilitating network connectivity of a wireless communication device in an Integrated Access and Backhaul, IAB, communication system including an IAB node associated with one or more mobile cells, as recited in claim 27 of the accompanying claims.

In an example, the method at the IAB node may comprise: sending information, such as in a BOUND CELL INFORMATION message broadcasted by the IAB node, for identifying one or more other mobile cells as bound mobile cells to which at least one of the one or more mobile cells are bound.

In accordance with a third aspect of the present invention, there is provided a method for use in facilitating network connectivity of a wireless communication device in an Integrated Access and Backhaul, IAB, communication system including an IAB donor node managing a connection between the wireless communication device and a serving mobile cell serving the wireless communication device, as recited in claim 35 of the accompanying claims.

In an example, the method at the IAB donor node may comprise: sending, to the wireless communication device, information, such as in a CONFIGURATION INFORMATION message, for identifying one or more other mobile cells as bound mobile cells to which the serving mobile cell is bound.

In accordance with a fourth aspect of the present invention, there is provided a method for use in an Integrated Access and Backhaul, IAB, communication system including an IAB donor node, as recited in claim 44 of the accompanying claims.

In an example, the method at the IAB donor node may comprise: receiving configuration information, such as bound cell global configuration information, for identifying one or more lists of mobile cells that are bound to each other and that are associated with one or more IAB nodes managed by the IAB donor node.

In accordance with a fifth aspect of the present invention, there is provided a method for use in facilitating network connectivity of a wireless communication device in an Integrated Access and Backhaul, IAB, communication system including an IAB donor node, as recited in claim 49 of the accompanying claims.

In an example, the method at the IAB donor node may comprise: receiving, from a wireless communication device, a request, such as a CONNECTION SETUP REQUEST, for setting up a connection with a mobile cell associated with an IAB node managed by the IAB donor node; in the case where the mobile cell requested for connection is bound to one or more other mobile cells, sending, to the wireless communication device, information for identifying one or more other mobile cells as bound mobile cells to which the mobile cell requested for connection is bound. For example, the information may be bound cell information sent in a CONNECTION SETUP RESPONSE.

In accordance with another aspect, there is provided a method for use in facilitating network connectivity of a wireless communication device in an Integrated Access and Backhaul, IAB, communication system including an IAB donor node managing a connection between the wireless communication device and a serving mobile cell serving the wireless communication device, the wireless communication device being on-board with an IAB node associated with the serving mobile cell, the method at the IAB donor node comprising: in a case where the serving mobile cell is bound with one or more other mobile cells, allowing the handover of the wireless communication device with IAB nodes associated with the one or more other mobile cells to which the serving mobile cell is bound and not allowing handover of the wireless communication device with an IAB node which is not associated with the one or more other mobile cells to which the serving mobile cell is bound. In other words, the IAB donor node may only allow handover of the wireless communication device with an IAB node which is associated with the one or more other mobile cells to which the serving mobile cell is bound. The IAB donor node may only allow the handover with an IAB node which is associated with the one or more other mobile cells to which the serving mobile cell is bound (i.e. the IAB donor node will not allow handover with an IAB not associated with a bound mobile cell) whilst the wireless communication device is or remains on-board with the IAB node associated with the serving mobile cell. The wireless communication device is or remains on-board with the IAB node where the movement or the wireless communication device is similar to the mobile IAB node's movement. For example, a wireless communication device which is on-board with an IAB node is typically a wireless communication device (e.g., UE) that is located inside a vehicle on which the IAB node is mounted. The IAB donor node may determine whether the wireless communication device is on-board with the IAB node (i.e. the on-board status of the wireless communication device): for example, from measurements the IAB donor node itself makes or from information/notification provided by the wireless communication device.

In accordance with a sixth aspect of the present invention, there is provided an apparatus for a wireless communication device as recited in claim 63 of the accompanying claims.

In accordance with a seventh aspect of the present invention, there is provided an apparatus for an IAB node as recited in claim 64 of the accompanying claims.

In accordance with a eighth aspect of the present invention, there is provided an apparatus for an IAB donor node as recited in claim 65 of the accompanying claims.

Determining whether a serving mobile cell serving the wireless communication device is bound to one or more other mobile cells or whether there are one or more preferred mobile cells other than a serving mobile cell makes it possible to benefit from the extra connectivity resulting from the presence of bound mobile cells (or preferred mobile cells) in the topology to enhance service continuity or cell reselection process while mitigating the connectivity impact that may result from the actual mobility status of the wireless communication device (e.g. a UE) and the bound or preferred mobile cells. For example, by determining or identifying bound mobile cells that are bound to a serving cell of a wireless communication device, such as a UE, enables the UE to give precedence to a bound mobile cell over non-bound neighbouring cells for cell reselection or Conditional Handover (CHO). In the case where the UE is onboard a vehicle (e.g. an onboard UE device), ignoring the non-bound neighbouring cells and giving precedence to a bound mobile cell for cell reselection or CHO can prevent the onboard UE from connecting transiently to fixed or mobile cells that may come into range of the onboard UE device but only for a limited time with the result that potential sequences of disconnection/reconnection that would affect the service continuity at the UE device can be avoided.

Further example features of the invention are described in other independent and dependent claims.

Any feature in one aspect of the invention may be applied to other aspects of the invention, in any appropriate combination. In particular, method aspects may be applied to apparatus/device/unit aspects, and vice versa.

Furthermore, features implemented in hardware may be implemented in software, and vice versa. Any reference to software and hardware features herein should be construed accordingly. For example, in accordance with other aspects of the invention, there are provided a computer program comprising instructions which, when the program is executed by one or more processing units, cause the one or more processing units to carry out the method of any aspect or example described above and a computer readable storage medium carrying the computer program.

### BRIEF DESCRIPTION OF THE DRAWINGS

Different aspects of the invention will now be described, by way of example only, and with reference to the following drawings in which:

FIG. 1 is a schematic diagram illustrating an example wireless communication system in which the present invention may be implemented according to one or more embodiments;

FIGS. 2a and 2b are schematic diagrams illustrating stacks of some protocol layers involved in IAB operations;

FIG. 3 is a schematic diagram illustrating the format of a BAP Protocol Data Unit (PDU) or packet;

FIG. 4 is a schematic diagram illustrating an example wireless communication system (or IAB network) in which the present invention may be implemented according to one or more embodiments;

FIG. 5, FIG. 6 and FIG. 7 are schematic and simplified diagrams illustrating example message flows for managing or facilitating the connectivity of a wireless communications device, such as a UE, to bound mobile cells in accordance with one or more embodiments of the invention;

FIG. 8a is a flowchart of an example method, performed at a wireless communication device, such as a UE, for determining one or more cells bound to its serving cell according to one or more embodiments of the present invention;

FIG. 8b is a flowchart of an example method for determining by a wireless communication device, such as a UE, one or more cells bound to its serving cell according to one or more embodiments of the present invention;

FIG. 9 is a flowchart of an example method for sharing by a mobile IAB node information on the cells bound to one or more cells it is serving according to one or more embodiments of the present invention;

FIGS. 10 and 11 are flowcharts of example methods for sharing by a network device, such as an IAB Donor node, information on the cells bound to the cell a served wireless communications device (such as a UE) is connected to according to one or more embodiments of the present invention;

FIG. 12 is a flowchart of an example method for managing or facilitating network connectivity of a wireless communications device, such as a UE, to bound mobile cells according to one or more embodiments of the present invention;

FIG. 13 is a flowchart of an example method for managing the connectivity of a wireless communications device, such as a UE, to bound cells by the wireless communication device, according to one or more embodiments of the present invention;

FIG. 14 is a flowchart of an example method for managing or facilitating the connectivity of a wireless communications device, such as a UE, to bound cells by a network device, such as an IAB Donor node, according to one or more embodiments of the present invention;

FIG. 15 is a block schematic diagram of an example wireless communication device in accordance with embodiments of the present invention;

FIG. 16 is a flowchart of an example method for managing or facilitating the connectivity of a wireless communications device, such as a UE, to bound cells by a network device, such as an IAB Donor node, according to one or more embodiments of the present invention.

### DETAILED DESCRIPTION

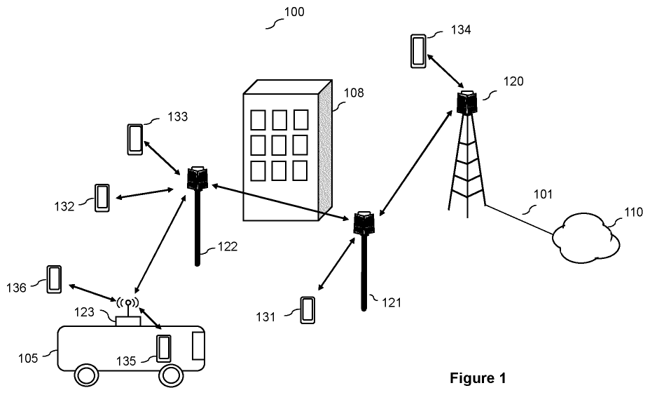

FIG. 1 illustrates an example communication system 100 in which the present invention may be implemented according to one or more embodiments.

As depicted, the example system 100 is a wireless communication system, in particular a mobile radio communication system such as a fifth-generation (5G) New Radio (NR) system including a wireless Integrated Access and Backhaul (IAB) communication system or network. Although in the following description, embodiments and examples of embodiments of the present invention will be described with respect to a 5G NR system, it will be appreciated that it is not intended that the present invention is limited to 5G NR systems and may be used in any wireless communication systems having an integrated access and backhaul communication system which shares radio resources for wireless access links and wireless backhaul links.

The system 100 comprises a plurality of UEs (User Equipment) 131, 132, 133, 134, 135 and 136, a remote core network 110, a main Base Station 120, two fixed Integrated Access and Backhaul (IAB) stations 121 and 122 or IAB nodes 121 and 122 (also referred to in the following as IAB-nodes) and a mobile Integrated Access and Backhaul (IAB) station or mobile IAB node 123, which in the example shown in FIG. 1 is mounted on a vehicle 105 (for example, a bus, a train, a taxi, a car, etc.).

The main Base Station 120, also referred to as the IAB-donor 120 (or IAB donor), is connected to the core network 110 through a wired link 101, preferably an optical fiber or any other wired means. In embodiments and examples of embodiments of the invention, IAB-donor 120 is a 5G NR base station (referred to as a gNB) with additional functionality to support IAB features, as defined in 3GPP TS 38.300 v 17.0.0 specification document.

In order to extend the network coverage of IAB-donor 120 and reach the remote UEs 132, 133 and 131, IAB stations 121 and 122, also referred to as IAB-nodes 121 and 122, have been installed by the operator. By acting as relaying nodes between the IAB-donor 120 and the UEs 131, 132 and 133, IAB-nodes 121 and 122 allow overcoming the reachability issue resulting from presence of building 108, which is an obstacle to the propagation of radio waves and hence to the direct attachment and further communications between the UEs and the IAB-donor 120. This is particularly true when the communications between the IAB-donor 120 and UEs 131, 132 and 133 are operated at millimeter wave frequencies, which are highly sensitive to shadowing phenomena.

The IAB-donor 120 also serves UE 134, which is directly connected to it.

The Mobile IAB station 123, also referred to as IAB-node 123 or mIAB node 123, which is mounted on vehicle 105, also provides network coverage and capacity extension, allowing the IAB-donor 120 to reach onboard remote UEs, like remote UE 135, as well as surrounding UEs or UEs in the vicinity of the IAB-node 123, like remote UE 136.

The IAB-donor 120 and the IAB-nodes 121, 122 and 123 are thus forming a backhaul network or IAB network (also referred to as IAB topology), which accommodates UEs 131, 132, 133, 134, 135 and 136. The terms IAB network and IAB topology will be used interchangeably in the following. The IAB network forms the Radio Access Network (RAN) or as referred to with respect to 5G, Next Generation (NG) RAN.

The specification of the Integrated Access and Backhaul (IAB) is spread over several 3GPP standard documents, including:
TS 38.300 RAN architecture (V17.0.0),
TS 38.321 MAC protocol (V17.0.0),
TS 38.331 Radio Resource Control (RRC) protocol (V17.0.0),
TS 38.340 Backhaul Adaptation Protocol Layer (V17.0.0),
TS 38.401 RAN architecture (V17.0.0),
TS 38.473 F1 Application Protocol (V17.0.0).

As IAB-nodes 121, 122 and 123 are respectively connected to UEs 131, 132, 133, 134, 135 and 136, they are considered as Access IAB-nodes for their respectively connected UEs.

The IAB-donor 120 is a logical node that provides the NR-based wireless backhaul and consists of a central unit (CU or gNB-CU functionality) and connected donor distributed unit(s) (DU or gNB-DU functionality). The IAB-donor-CU or donor CU (also referred to in the following as IAB-donor CU or IAB donor CU) hosts higher layer protocols, such as PDCP (Packet Data Convergence Protocol) and RRC (Radio Resource Control) protocols, for controlling operation of one or more DUs and each of the one or more IAB-donor-DUs or donor DUs (also referred to in the following as IAB-donor DU or IAB donor DU) includes lower layer protocols, such as the RLC, MAC and physical layer protocols. The IAB-donor CU and IAB-donor DU may be located far from the other or may be located in the same physical device. The gNB-DU functionality is defined in 3GPP TS 38.401. It aims at terminating the NR access interface to the UEs and next-hop IAB-nodes, and at terminating the F1 protocol to the IAB-donor gNB-CU functionality.

The IAB nodes, which may serve multiple radio sectors or cells, are wireless backhauled to the IAB-donor 120, via one or multiple hops (e.g. via one or more IAB-nodes). They form a directed acyclic graph (DAG) topology with the IAB-donor at its root.

Each IAB node consists of an IAB-DU (IAB-Distributed Unit) and an IAB-MT (IAB-Mobile Termination). The gNB-DU functionality on an IAB-node is also referred to as IAB-DU and allows the downstream (toward the UE) connection to the next-hop IAB or to a UE. The IAB-MT functionality includes, e.g., physical layer, layer-2, RRC and Non Access Stratum (NAS) functionalities to connect to the gNB-DU of an upstream IAB-node (including the IAB-donor 120 in which case it connects to the IAB-donor gNB-CU, hence to the core network 110, for instance for initialization, registration and configuration).

In this DAG topology, the neighbour node on the IAB-DU's interface is referred to as child node and the neighbour node on the IAB-MT's interface is referred to as parent node. The direction toward the child node is further referred to as downstream while the direction toward the parent node is referred to as upstream.

The IAB-donor 120 (e.g. the IAB-donor CU) performs centralized resource, topology and route management for the whole IAB topology. This includes configuring the IAB-nodes according to the network topology, e.g. in order to perform appropriate routing of data packets.

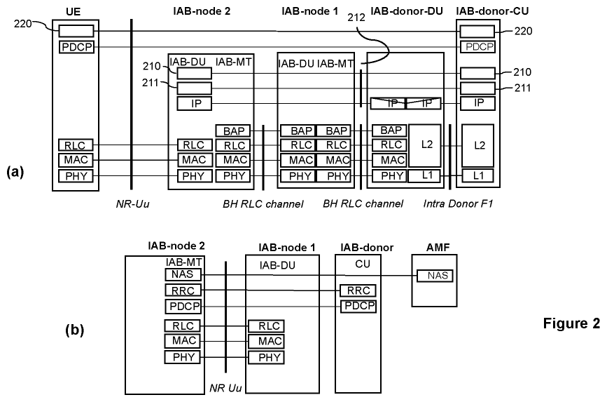

FIGS. 2a and 2b schematically illustrate stacks of some protocol layers involved in IAB operations.

F1 interface supports the exchange of signalling information between the endpoints, as well as the data transmission to the respective endpoints. From a logical standpoint, F1 interface is a point-to-point interface between the endpoints.

In 5G NR, F1-C is the functional interface in the Control Plane (CP) between the IAB-donor-CU and an IAB-node-DU. F1-U is the functional interface in the User Plane (UP) for the same units. F1-C and F1-U are shown by reference 212 in FIG. 2a. In this example, F1-U and F1-C are carried over two backhaul hops (from IAB-donor to IAB-nodel and then from IAB-node1 to IAB-node2).

In the User Plane, boxes 210 at the IAB-donor CU and the IAB-node DU refer to the GTP-U layer and boxes 211 refer to the UDP layer. GTP-U stands for GPRS Tunnelling Protocol User Plane. GTP-U Tunnels are used to carry encapsulated PDUs and signaling messages between a given pair of GTP-U Tunnel Endpoints (refer to 3GPP TS 29.281 for more details), here boxes 210 at the IAB-donor CU and the IAB-node DU. The well-known User Datagram Protocol (UDP) is a transport layer protocol providing a best effort datagram service and fit to use with an IP protocol.

In the Control Plane, boxes 210 indicate the F1AP (F1 Application Protocol) layer and boxes 211 indicate the SCTP (Stream Control Transmission Protocol) layer. The F1 Application Protocol (as defined in 3GPP TS 38.473 and TS 38.401) provides signalling services between the IAB-donor CU and the IAB-node DU, or UE associated services. These services are for example initialization, configuration, and so on. The well-known SCTP layer provides reliable, in sequence transport of messages with congestion control.

F1-U and F1-C rely on an IP transport layer between the IAB-donor CU and the IAB-node DU as defined in 3GPP TS 38.401.

The transport between the IAB-donor DU and the IAB-donor CU also uses an IP transport Layer over various media, like for example wires or optical fiber when the IAB-donor CU is remote from the IAB-donor DU, or locally in a virtual instantiation of the IAB-donor CU and the IAB-donor DU on the same physical machine. IAB-specific transport between IAB-donor-CU and IAB-donor-DU is specified in 3GPP TS 38.401.

L1 and L2 on the Figure stand respectively for the transport and physical layers appropriate to the medium in use.

The IP layer can also be used for non-F1 traffic, such as Operations, Administration and Maintenance traffic.

On the wireless backhaul, the IP layer is itself carried over the backhaul adaptation protocol (BAP) sublayer, which enables routing over multiple hops. The BAP sublayer is specified in TS 38.340.

The IAB-DU's IP traffic is routed over the wireless backhaul via the BAP sublayer. In a downstream direction, upper layer packets are encapsulated by the BAP sublayer at the IAB-donor DU, thus forming BAP packets or packet data units (PDUs) or data units. The BAP packets are routed by the BAP layer (and corresponding BAP entities in the IAB-DU and IAB-MT) of the intermediate IAB-nodes, if any. The BAP packets are finally de-encapsulated by the BAP sublayer at the destination IAB-node (which may be an access IAB-node should the upper layer packets in the BAP packets be intended for a UE).

In an upstream direction, upper layer packets are encapsulated by the BAP sublayer at an initiator IAB-node (which may be an access IAB-node should the upper layer packets come from a UE), thus forming BAP packets or PDUs or data units. The BAP packets are routed by the BAP layer (and corresponding BAP entities in the IAB-DU and IAB-MT) of the intermediate IAB-nodes, if any. The BAP packets are finally de-encapsulated by the BAP sublayer at the IAB-donor DU.

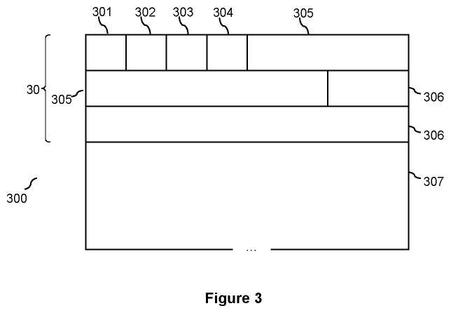

On the BAP sublayer, packets are routed based on the BAP routing ID, which is carried in the BAP header and which is set by the BAP sublayer of the network node in the IAB network generating the BAP packets. FIG. 3 illustrates the format of a BAP Data Protocol Data Unit (PDU) or packet. It is specified in the standardized version paragraph 6.2 of 3GPP TS38.340 release 17.0.0.

The header 30 includes fields 301 to 306. Field 301, named D/C field, is a Boolean indicating whether the corresponding BAP packet is a BAP Data packet or a BAP Control packet. Fields 302-304 are 1-bit reserved fields, preferably set to 0 (to be ignored by the receiver).

Fields 305 and 306 indicate together the BAP routing ID for the BAP packet. BAP address field 305, also referred to as DESTINATION field, is located in the leftmost 10 bits while BAP path identity field 306, also referred to as PATH field, is located in the rightmost 10 bits.

Field 305 carries the BAP address (i.e. on the BAP sublayer) of the destination IAB-node or IAB-donor DU for the BAP packet. For the purpose of routing, each IAB-node and IAB-donor DU is configured (by an IAB-donor CU which controls the IAB network or topology to which the IAB-node and IAB-donor DU belong) with a designated BAP address. Field 306 carries a path ID identifying the routing path the BAP packet should follow to this destination in the IAB topology. The routing paths, including their path IDs, are configured in the same way the BAP address is configured.

The BAP header is added to the packet when it arrives from upper layers to the BAP layer, and it is stripped off by the BAP layer when it has reached its destination node. The selection of the packet's BAP routing ID is configured by the IAB-donor-CU.

For instance, when the BAP packet is generated by an IAB-node, i.e. either by the IAB-donor for downstream transmission or by an initiator IAB-node for upstream transmission (which may be an access IAB-node should the upper layer packets come from a UE), the BAP header with the BAP Routing ID is built by this IAB-node according to a configuration table defined in 3GPP TS 38.340. This table is called Downlink Traffic to Routing ID Mapping Configuration table in the IAB-donor or Uplink Traffic to Routing ID Mapping Configuration table in the initiator IAB-node. In intermediate IAB-nodes, the BAP header fields are already specified in the BAP packet to forward.

As mentioned above, these configuration tables defining the BAP paths (hence the routing strategy and the configuration of the IAB-nodes given the IAB network topology) are usually defined by the IAB-donor-CU controlling the IAB network and transmitted to the IAB-nodes to configure them.

To process the transport of messages over the 5G NR radio medium, three more sublayers (RLC, MAC and PHY) are implemented at each IAB-node below the BAP sublayer. The RLC (Radio Link Control) sublayer is responsible for the segmentation or reconstruction of packets. It is also responsible for requesting retransmissions of missing packets. The RLC layer is further described in TS38.322. The MAC (Media Access Channel) protocol sublayer is responsible for selecting available transmission formats for the user data and for the mapping of logical channel to the transport channels. The MAC handles also a part of the Hybrid Automated Repetition request scheme. The MAC layer is detailed in TS 38.321. On the emitter side or transmitter side, the MAC encapsulates the data packet issued from the RLC. It adds a header carrying information necessary to the MAC function. On the receiver side, the MAC decapsulates the data packet issued from the PHY, deletes its header and passes the remaining data to the RLC. The PHY sublayer provides an electrical interface to the transmission medium (the air) by converting the stream of information into physical modulation signals, modulating a carrier frequency at the emitter side. At the receiver side the PHY sublayer converts the physical modulation signals back to a stream of information. The PHY layer is described in TS 38.201, TS 38.211, TS 38.212, TS 38.213, TS 38.214.

To pass messages towards the user or control plane, two other sublayers are used in the UE and IAB-donor-CU: the PDCP (Packet Data Convergence Protocol) sublayer and either the SDAP (Service Data Adaptation Protocol) sublayer for the User Plane communications or the RRC (Radio Resource Control) sublayer for the Control Plane communications.

The PDCP sublayer handles IP Header compression/decompression, ciphering/deciphering, and handles the integrity on the data packet if necessary. It mandatorily numbers the packets on the emitter side and reorders the packets on the receiver side. The PDCP sublayer is described in 3GPP TS38.323.

SDAP sublayer 220 for the User Plane handles the Quality of Service. It is described in TS38.324. On the UE side, the SDAP sublayer exchanges the payload data with the user's application (voice, video, etc . . . —not shown in the Figure). On the IAB-donor side, the SDAP sublayer exchanges the data with the Core Network 110 (Internet traffic, Cloud, etc . . . ).

RRC sublayer 220 for the Control Plane handles the configuration of the protocol entities of the User Plane protocol stack. It is described in TS38.331. It is responsible for the handling of, inter alia, broadcasting information necessary to a UE to communicate with a cell; transmitting paging messages, managing connection, including setting up bearers; mobility functions; measurement configuration and reporting; devices capabilities.

The interface (for both CP and UP) between nodes using the layers PDCP, RLC, MAC and PHY is referenced NR-Uu. This mainly concerns the interface with the UE.

The interface (for both CP and UP) between nodes using the layers BAP, RLC, MAC and PHY is named BackHaul RLC Channel (BH RLC channel). This mainly concerns the interfaces between the IAB-nodes.

NR-Uu is the interface between the UE and the radio access network, i.e. its access IAB-node (for both CP and UP).

FIG. 2b comes from 3GPP TS 38.300 v17.0.0 and illustrates the protocol stack for the support of IAB-MT's RRC and NAS connections. The Non-Access Stratum (NAS) protocol handles the messages between the core network and a user equipment, here an IAB-node. It manages the establishment of communication sessions and maintains communications with the user equipment as it moves. The 5G NAS is described in 3GPP TS 24.501. The 5G Core Access and Mobility Management Function (AMF) is a function within the Core Network that receives all connection and session related information from the UEs connected to the IAB node, as well as similar information for the IAB-node. AMF is only responsible for handling connection and mobility management tasks.

The IAB-MT establishes signalling Radio Bearers SRBs (bearers carrying RRC and NAS messages) with the IAB-donor-CU. These SRBs are transported between the IAB-MT and its parent node(s) over NR-Uu interface(s).

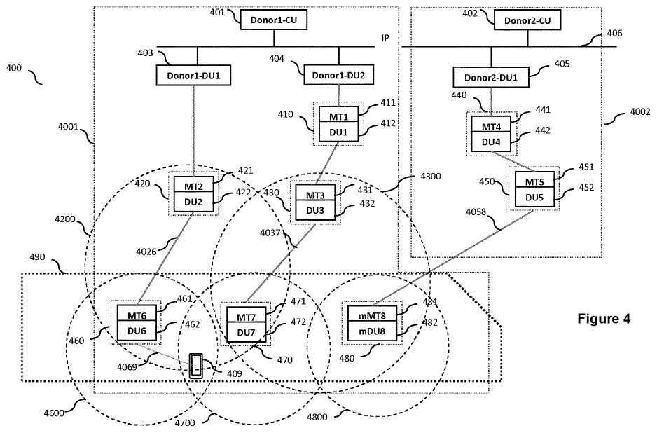

FIG. 4 illustrates an example of a wireless communication system 400 (e.g. an IAB communication system), including an IAB network or IAB network system, in which embodiments and examples of embodiments of the present invention may be implemented. In one example implementation, the radio links between the IAB nodes and IAB donor DU nodes (referred to as BH radio links) are operated over the millimeter wave frequency band (i.e. above 30 GHz), which is highly sensitive to radio channel disturbance. An IAB network will also be referred to as an IAB topology or topology and so in this application, the terms IAB network and IAB topology and topology will be used interchangeably.

The IAB network system of FIG. 4, which forms part of the NG RAN, is composed of two IAB networks or IAB topologies 4001 and 4002 with each IAB topology comprising a set of IAB nodes (e.g. the set may comprise a plurality of IAB nodes or at least one IAB node) and a IAB-donor CU for controlling or managing the set of IAB nodes. The set of IAB nodes may include one or more IAB-nodes, such as initiator IAB-nodes which generate BAP packets and also intermediate or relay IAB-nodes. The set of IAB nodes may also include one or more IAB donor DUs. Each of the IAB nodes communicate with at least one other IAB node over a wireless backhaul (BH) link.

Although FIG. 4 shows two IAB topologies 4001 and 4002, the present invention is not limited to two IAB topologies 4001 and 4002 and may be implemented in an IAB communication system comprising more than two IAB topologies with each topology comprising a set of IAB nodes and an IAB donor CU as discussed above.

IAB topology 4001 includes IAB-donor-CU 401 (identified as Donor1-CU in FIG. 4), its associated IAB-donor-DUs, IAB-donor-DU 403 (identified as Donor1-DU1 in FIG. 4) and IAB-donor-DU 404 (identified as Donor1-DU2 in FIG. 4), and a plurality of IAB nodes 410, 420, 430, similar to IAB-nodes 121 and 122, and mobile IAB-nodes 460, 470, 480, similar to mobile IAB-node 123.

IAB topology 4002 includes IAB-donor-CU 402 (identified as Donor2-CU in FIG. 4), and its associated IAB-donor-DU 405 (identified as Donor2-DU1 in FIG. 4), and a plurality of IAB-nodes 440 and 450, similar to IAB-nodes 121 and 122. The IAB network system of FIG. 4 can provide network path diversity through several IAB-donor-DUs and different IAB networks or topologies.

As discussed above, each IAB node comprises a Mobile Termination (MT) part or unit, controlled and configured by the IAB donor using RRC messaging as defined in 3GPP TS 38.331, and a Distributed Unit (DU) part, controlled and configured by the IAB donor using F1-AP messaging as defined in 3GPP TS 38.473. For example, IAB-node 410 comprises a MT part or unit 411 and a DU part 412.

A wired backhaul IP network interconnects the IAB-donor-CUs 401 and 402, and the IAB-donor-DUs 403, 404 and 405 through wired link 406. For instance, this wired link consists of optical fiber cable(s).

IAB-Donor-CU 401, IAB-Donor-DUs 403 and 404, IAB-nodes 410, 420, 430, 460, 470 and IAB-node 480 are part of the same IAB network or IAB topology 4001, which is controlled (e.g., configured and/or managed) by IAB-Donor-CU 401.

IAB-Donor-CU 402, IAB-Donor-DU 405 and IAB-nodes 440 and 450 are part of the same IAB network or IAB topology 4002, which is controlled (e.g. configured and/or managed) by IAB-Donor-CU 402.

IAB-node 460 is connected to the parent IAB-node 420 through BH link 4026. IAB-node 460 is also connected to a UE 409 through communication link or radio link 4069: the IAB-node 460 is acting as an access node for UE 409. Although FIG. 4 shows only one UE 409, it will be appreciated that there will be a plurality of UEs connected to IAB nodes of the wireless communication system.

Each IAB-node supports wireless communication in a coverage area referred to as a cell. In other words, each IAB-node is associated with a cell. For instance, IAB nodes 420, 430, 460, 470 and 480 are respectively associated with cells 4200, 4300, 4600, 4700 and 4800.

Wireless communication devices (such as UEs, or other IAB-nodes) located within the cell may connect to the IAB-node serving the cell in order to communicate with other devices (e.g., other Ues, IAB-nodes, servers providing access to the Internet, etc.) via the IAB-node. Typically, an IAB-node measures signals from IAB-node of adjacent cells as part of a cell search procedure (e.g., when initially connecting to the network as defined in 3GPP TS 38.300) or as part of a subsequent procedure. The measurements are reported to the IAB donor CU of the IAB-node. For example, with reference to FIG. 4, the IAB-node 480 may report to its IAB donor CU 401 the presence of a new cell served by IAB-node 450 through a measurement report. Based on the analysis of the measurement report (e.g. measurements in the report indicate the signal strength provided by the IAB-node 450 is above a threshold for supporting communications), the IAB donor CU 401 may request to the IAB donor CU 402, to which the IAB-node 450 belongs, the establishment of a dual connectivity for the IAB-node 470 with an additional connection through the IAB-node 450. The IAB donor CU 402 may accept the request and proceed to establish the connection (represented by BH link 4058 in FIG. 4) of the IAB-node 480 to the IAB-node 450 according to the procedure described in TS 37.340 v17.0.0 section 10.2. As a result, the IAB-node 480, still belonging to IAB topology 4001, is now also connected to IAB-node 450, which belongs to IAB topology 4002, and so it may be referred to as a boundary node between IAB topology 4001 and IAB topology 4002. Actually, the IAB-node 480 retains its F1 connection and its RRC connection to the IAB donor CU 401, which can be referred to as the F1-terminating IAB-donor-CU, and it has a second RRC connection with the IAB donor CU 402, which can be referred to as the non-F1-terminating IAB-donor-CU.

As IAB-node or boundary node 480 is part of the IAB topology 4001 (from the F1 connection point of view), it is controlled (e.g., configured and/or managed) by the IAB-Donor-CU 401 of IAB topology 4001. Through the second RRC connection, the IAB donor CU 402, assigns a second BAP address to be used for routing packets through the IAB topology 4002. Thus, IAB-node 480 acting as a boundary node is assigned two BAP addresses: one BAP address for IAB network 4001 and one BAP address for IAB network 4002. Such a boundary node can help provide network path diversity by providing alternative routing paths through the IAB topologies 4001 and 4002.

Mobile IAB nodes 460, 470 and 480 may be mounted on the same vehicle 490 (e.g., vehicle 490 may be a train or a bus) to enhance the coverage while optimizing the radio resources sharing. Thus, mobile IAB nodes 460, 470 and 480 are moving together and the cells 4600, 4700 and 4800 associated with the mobile IAB nodes 460, 470 and 480 are also moving together and can be considered as bound cells. In other words, cell 4600 is bound to (or related to or linked to or associated with) cell 4700 and also cell 4800 and similarly cell 4700 is bound to (or related to or linked to or associated with) cell 4600 and also cell 4800 and similarly cell 4800 is bound to (or related to or linked to or associated with) cell 4600 and also cell 4700. Cells may be considered to be bound to each other when the movement of each of the cells is related or linked, such as when the movement of each of the cells is similar or substantially the same (e.g., the cells are moving together in substantially the same direction and at substantially the same speed). In the case shown in FIG. 4, the movement of each of the cells 4600, 4700, 4800 (and IAB nodes 460, 470 and 480) is related or linked because the IAB nodes 460, 470 and 480 associated with the cells are mounted on the same vehicle 490. In this application, cells that are bound to (or related to or linked to or associated with) each other are referred to as bound cells and IAB nodes that are associated with (e.g. manage or control) the bound cells are referred to as bound IAB nodes. An IAB node may control one or more cells. It will be appreciated that bound cells may include one or more cells managed by the same IAB node. In other words, one or more cells managed by the same IAB node may be bound to (or related to, linked with or associated with) each other and to one or more other cells. Thus, for example, an IAB node associated with the serving mobile cell is mounted on a vehicle, a mobile cell determined to be bound to the serving cell may be managed by the same IAB node associated with the serving mobile cell (which is thus mounted on the vehicle) or the mobile cell determined to be bound to the serving cell may be managed by another IAB node which may also be mounted on the vehicle (and the wireless communication device is on board the vehicle).

In another example, fixed cells may be considered to be bound to (or linked to or associated with) each other when there is a relationship between two or more fixed cells.

For instance, several fixed cells belonging to a railway station or bus station or to the same building located nearby a taxi or bus station may be bound together so as to allow a UE device who is supposed to remain at the railway station or in the aforementioned building (e.g., a person working at the train station or in the building) to preferably connect to a bound fixed cell instead of another fixed cell or a mobile cell (e.g., train, bus, taxi). Thus, more generally two or more fixed cells belonging to or associated with (i.e. located at) the same building or fixed location, which building or fixed location is located near a location where there are likely to be mobile cells in the vicinity (as well as fixed cells), may be identified as bound fixed cells and so bound together so as to allow a UE, which will, or will for some time, remain at the building or at the fixed location, to preferably connect to one of the bound fixed cells instead of a non-bound fixed cell or a mobile cell.

Thus, in general terms two or more cells (whether mobile or fixed) may be bound to (or linked to or associated with) each other when there is a certain relationship between the two or more cells. The description herein is focused on two or more mobile cells being bound to each other. However, the description, examples, embodiments and claims may instead apply to fixed bound cells. In one example, two or more cells (whether mobile or fixed) may be bound to (or linked to or associated with) each other when the two or more cells are considered as some preferential target cells for performing cell reselection for a UE in range of one or more of said two or more cells, regardless of the actual location or relative positioning of said two or more cells.

UE 409 may be an on-board UE for vehicle 490, i.e., the movement of UE 409 is similar to vehicle 490's movement. For instance, on-board UE 409 may be a smartphone located inside vehicle 490, which may be a bus or a train. As UE 409 is served by mobile IAB node 460 through the 4600 cell, UE 409 may also be considered as an on-board UE for mobile IAB node 460.

As on-board UE 409 is moving along with its serving mobile cell 4600, it may be in the vicinity of other potential access IAB nodes, like fixed IAB nodes 420 or 430. However, due to the mobility of IAB node 460, the link quality between on-board UE 409 and these potential fixed access IAB nodes is likely to evolve rapidly. Therefore, UE 409 should keep its connection to cell 4600 managed by mobile IAB-node 460 or to one of the cells bound to (or related to or linked to or associated with) cell 4600 (i.e., cells 4700 and 4800) and not perform any handover or cell reselection towards any other potential access IAB nodes as long as it is an on-board UE 409 for vehicle 490.

The processes for identifying the bound cells amongst the UE's neighbour cells, along with the associated connectivity management methods will now be described according to some embodiments of the present invention.

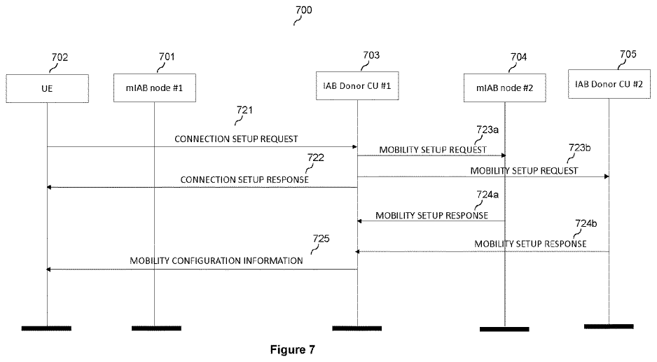

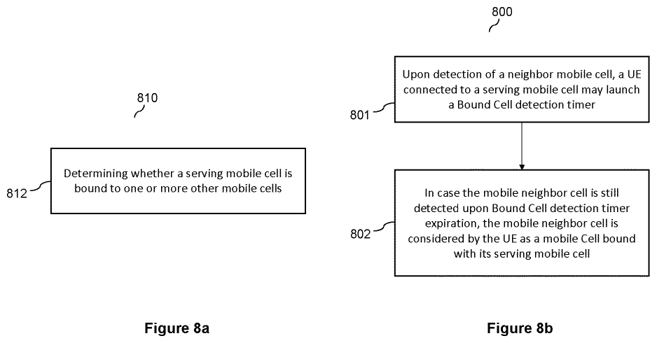

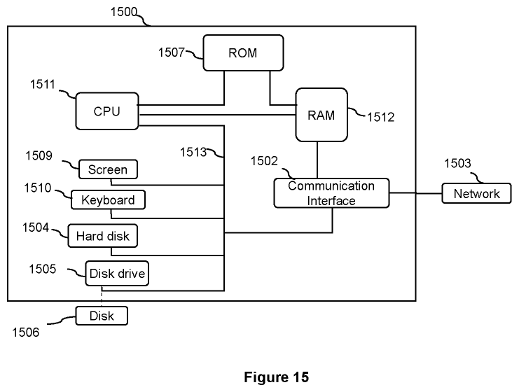

FIG. 8a is a flowchart for a method 810 performed at a wireless communication device. The wireless communication device may be a UE or a mobile IAB node. The following description relates to the case where the communication device is a UE but it is not intended for the invention to be limited to a UE. Method 810 is for use in facilitating network connectivity of the wireless communication device in an Integrated Access and Backhaul, IAB, communication system in accordance with one or more embodiments of the present invention. The IAB communication system may be, for example, the IAB communication as shown in FIG. 4 (FIG. 1). With respect to the example shown in FIG. 4, the wireless communication device performing method 810 may be UE 409. The method 810 as shown in and described with respect to FIG. 8a may be performed by software elements and/or hardware elements. Thus, for example, the method as shown in and described with respect to FIG. 8a may be performed by an apparatus for the wireless communication device comprising one or more processing units configured to carry out the method. The wireless communication device may be implemented in a communication device 1500 as shown in and described with reference to FIG. 15 with the method as shown in and described with respect to FIG. 8a being performed by one or more processing units, such as the central processing unit 1511.

Briefly, at step 812, the UE 409 determines whether a serving mobile cell serving the UE 409 is bound to one or more other mobile cells. As discussed above, a cell may be bound to (or related to, linked to or associated with) a mobile cell when movement of the cell is related to (or linked to) movement of the mobile cell such as when the movement of each of the cells is similar or substantially the same (e.g. the cells are moving together in substantially the same direction and at substantially the same speed such as when the IAB nodes associated with (or controlling or managing) the cells are mounted on the same moving vehicle). In the example shown in FIG. 4, mobile cells 4600, 4700 and 4800 are bound to each other as the IAB nodes 460, 470, 480 managing the mobile cells 4600, 4700 and 4800 are mounted on the same vehicle 490 (which may be a train, bus or other similar long vehicle) and thus, the movement of the mobile cells 4600, 4700 and 4800 is related.

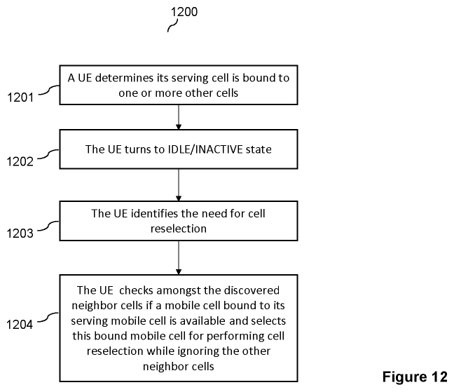

After determining a neighbouring cell (e.g. after the UE 409 performs a discovery procedure and discovers one or more neighbouring cells in proximity to or in the vicinity of the UE 409) is a bound mobile cell bound to the serving mobile cell, the UE 409 may perform cell reselection (or Conditional Handover, CHO) to the bound mobile cell in preference to other neighbouring cells which are discovered by the UE 409 but which are not bound to the serving mobile cell of the UE 409. In fact, when a neighbouring cell is determined to be a bound mobile cell by the UE 409, the UE 409 may ignore or not consider other neighbouring cells which are not bound mobile cells when performing cell reselection or CHO. Cell reselection is discussed in more detail with reference to FIG. 12.

The UE 409 may determine whether a serving mobile cell serving the UE 409 is bound to one or more other mobile cells in a number of different ways. For example, the UE 409 may determine whether a neighbouring cell is a bound mobile cell bound to the serving mobile cell 4600 based on measurements performed at the wireless communication device (e.g. as discussed below with reference to FIG. 8b).

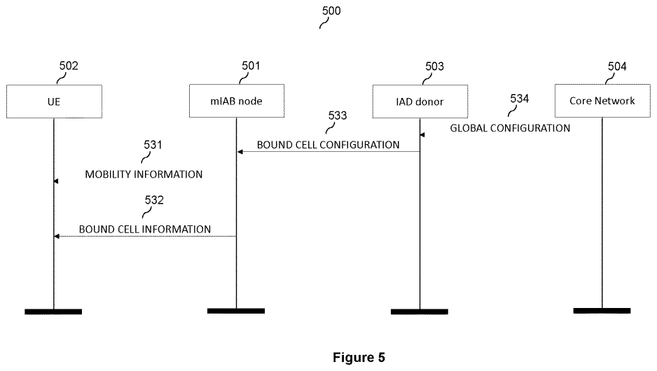

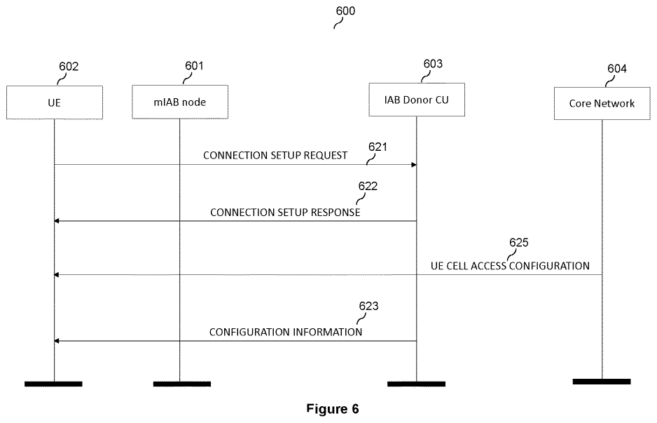

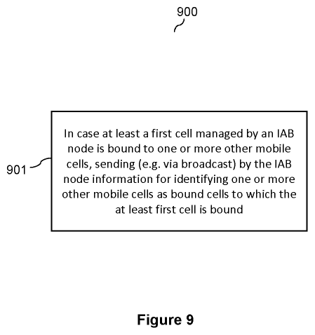

The UE 409 may additionally or alternatively determine whether a serving mobile cell serving the UE 409 is bound to one or more other mobile cells based on information received from an IAB node (e.g. as discussed below with reference to FIG. 5 and/or FIG. 9). For example, the information sent by the IAB node to the UE 409 may comprise bound cell information which may be sent in a BOUND CELL INFORMATION message 532 as discussed below. The information may be broadcast by the IAB node. The IAB node providing the information may be the IAB node 460 managing the serving mobile cell 4600 or may be another IAB node which manages one of the other mobile cells bound to the serving mobile cell 4600, such as mobile IAB node 470 or 480.

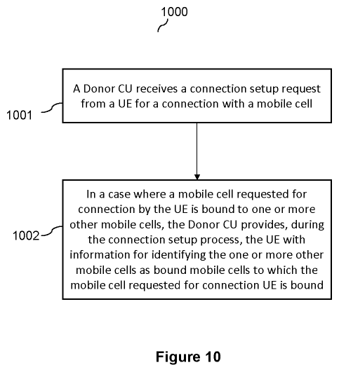

The UE 409 may additionally or alternatively determine whether a serving mobile cell serving the UE 409 is bound to one or more other mobile cells based on information received from an IAB donor node, such as a IAB donor CU (e.g. as discussed below with reference to FIG. 6/7 and/or FIG. 10/11).

In an example, the UE 409 may send a request for setting up a connection with a mobile cell associated with an IAB node managed by an IAB donor node (e.g. an IAB donor CU). With reference to FIG. 4, the UE 409 may send a request (such as a connection setup request in a CONNECTION SETUP REQUEST message 621 as described with reference to FIG. 6 and FIG. 10) to IAB donor CU 401 when requesting setting up a connection with mobile cell 4700 which is managed by IAB node 470 which is controlled by IAB donor CU 401. The UE 409 receives a response from the IAB donor CU 401, with the response including information for identifying one or more other mobile cells (such as cells 4600, 4800) as bound mobile cells to which the mobile cell 4700 requested for connection is bound. For example, the information sent by the IAB donor CU 401 to the UE 409 may comprise bound cell information which may be sent in a CONNECTION SETUP RESPONSE message 622 as discussed below. After a connection has been established with the requested mobile cell 4700, the requested mobile cell 4700 becomes the serving mobile cell serving the UE 409 and determining whether a serving mobile cell serving the UE 409 is bound to one or more other mobile cells can be made based on the information included in the response from the IAB donor CU 401 (e.g. for cell reselection or CHO as discussed below).

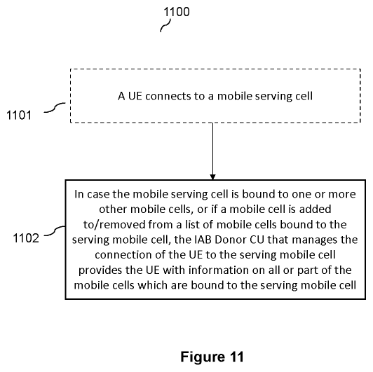

In an example, the UE 409 may receive, from an IAB donor node managing a connection between the UE 409 and a serving mobile cell serving the UE 409, information for identifying one or more other mobile cells as bound mobile cells to which the serving mobile cell is bound. With reference to the example of FIG. 4, the UE 409 which is served by mobile cell 4600 managed by IAB donor CU 401 receives information from the IAB donor CU 401 which information identifies mobile cells 4700 and 4800 as bound mobile cells to which the serving mobile cell 4600 is bound. For example, the information sent by the IAB donor CU 401 to the UE 409 may comprise bound cell information which may be sent in a CONFIGURATION INFORMATION message 623 as described with reference to FIG. 6 and FIG. 11. The information received from the IAB donor CU 401 may include update information including at least one of information for identifying one or more new mobile cells which have been added as bound mobile cells and information for identifying one or more mobile cells which have been removed as bound mobile cells.

The UE 409 may further receive from the IAB donor node (e.g. IAB donor CU) configuration information for Handover (HO) or Conditional Handover (CHO) for at least some of the one or more bound mobile cells (e.g. the bound mobile cells included in the list of bound cells or bound cell table provided at the UE 409). The configuration information may be provided in a MOBILITY CONFIGURATION INFORMATION message 725 as discussed below. After determining conditions for conditional handover to at least one of the one or more bound mobile cells are met (the conditions (such as link quality, etc.) for triggering CHO may be included in the configuration information provided by the IAB donor node), the UE 409 may perform handover to the at least one bound mobile cell. CHO can therefore be performed to a bound mobile cell in preference over other neighbouring cells.

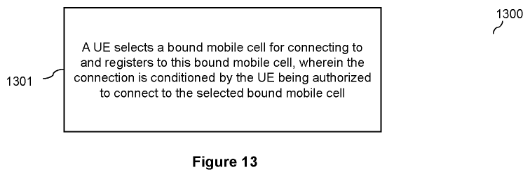

The UE 409 may receive cell access information identifying one or more of the mobile cells which have been determined by the UE 409 to be bound mobile cells (e.g. one or more of the bound mobile cells in a list/table of bound mobile cells) as restricted cells to which the wireless communication device is not allowed access. For example, the cell access information may include Cell Access information sent in a UE CELL ACCESS CONFIGURATION message 625 as described with reference to FIGS. 6 and 13.

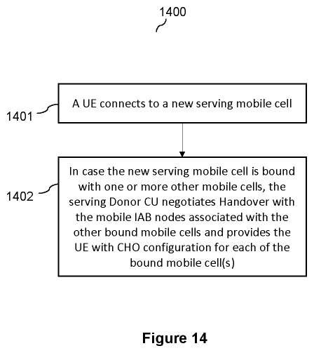

As mentioned above, although FIG. 8a has been described above with reference to bound mobile cells, the cells may be bound fixed cells. The above description applies accordingly. For example, the UE 409 determines whether a serving cell serving the UE 409 is bound to one or more other fixed cells. The determining may be based on information received by the UE 409 as discussed with reference to FIGS. 9, 10, 11 and 13. After determining a neighbouring cell (e.g. after the UE 409 performs a discovery procedure and discovers one or more neighbouring cells in proximity to or in the vicinity of the UE 409) is a bound fixed cell bound to the serving cell, the UE 409 may perform cell reselection (or Conditional Handover, CHO) to the bound fixed cell in preference to other neighbouring cells which are discovered by the UE 409 but which are not bound to the serving cell of the UE 409. In fact, when a neighbouring cell is determined to be a bound fixed cell by the UE 409, the UE 409 may ignore or not consider other neighbouring cells which are not bound cells when performing cell reselection or CHO. Cell reselection is discussed below with reference to FIG. 12 and the description below may be applied to cell reselection to a bound fixed cell. Providing CHO configuration to the UE 409 is discussed below with reference to FIG. 14 and the description below may be applied to providing CHO configuration to the UE 409 for bound fixed cells.

FIG. 8b is a flowchart of an example method for identifying or determining by a wireless communication device bound mobile cells, according to one or more embodiments of the present invention.

For example, with reference to the wireless communication system shown in and described with respect to FIG. 4, the wireless communication device performing the method 800 of FIG. 8b may be UE 409 or mobile IAB node 460.

The method 800 as shown in and described with respect to FIG. 8b, may be performed by software elements and/or hardware elements. Thus, for example, the method 800 as shown in and described with respect to FIG. 8b may be performed by an apparatus for the wireless communication device comprising one or more processing units configured to carry out the method. The UE or the mobile IAB node may be implemented in a communication device 1500 as shown in and described with reference to FIG. 15 with the method as shown in and described with respect to FIG. 15 being performed by one or more processing units, such as the central processing unit 1511.

Back to FIG. 8b, a UE 409, which is currently served by a mobile cell like cell 4600, may detect or identify a neighbour cell is a mobile cell by receiving, at step 801, indication information indicating the cell is a mobile cell, such as a mobile-IAB cell type indication, associated to a neighbour mobile cell, from a mobile IAB node (such as IAB node 4700 or 4800) in its vicinity. According to one aspect, the mobile-IAB cell type indication is received through a MOBILITY INFORMATION message 531, which is further described in FIG. 5.

For instance, UE 409, currently served by mobile cell 4600 managed by mobile IAB node 460, may receive a mobile-IAB cell type indication from mobile IAB node 470 indicating that cell 4700 is a mobile cell.

Upon detection of a neighbour mobile cell, the UE 409 may launch or start a Bound Cell Detection timer, which will be associated to the detected neighbour mobile cell.

Then, at step 802, the UE 409 will keep on monitoring the radio link quality associated with the previously detected neighbour mobile cell for which a Bound Cell Detection timer has been launched at step 801. If there is more than one detected neighbour mobile cell, the UE 409 will launch or start a Bound Cell Detection timer for each of the detected neighbour mobile cells and the UE 409 will monitor radio link quality associated with each of the previously detected neighbour mobile cells.

According to one aspect, the UE may consider a neighbour mobile cell as a mobile Cell bound with its serving mobile cell in case all or part of the following conditions is met:
the mobile neighbour cell is still detected when its associated Bound Cell detection timer expires (e.g. signals associated with (e.g. signals broadcast in) the detected mobile neighbour cell are still detected on expiry of the timer);
the link quality resulting from signal strength measurements associated to a mobile neighbour cell remained above a predefined threshold between the launch and the expiration of the associated Bound Cell detection timer (e.g. signal strength measurements of signals associated with (e.g. signals broadcast in) the detected mobile cell are above a certain threshold during a time period from starting of the timer to expiry of the timer);
the link quality resulting from signal strength measurements associated to a mobile neighbour cell remained stable, i.e., between a first a second predefined thresholds, between the launch and the expiration of the associated Bound Cell detection timer (e.g. signal strength measurements of signals associated with (e.g. signals broadcast in) the detected mobile cell are between first and second certain thresholds during a time period from starting of the timer to expiry of the timer).

According to an example, the signal strength measurements include all or part of the following metrics:
Reference Signal Received Power (RSRP), which provides a measure of the received power of the strongest reference signal from the considered cell.
Reference Signal Received Quality (RSRQ), which provides a measure of the quality of the received reference signal from the considered cell, relative to the interference level in the cell.
Signal-to-Noise Ratio (SNR), which provides a measure of the signal quality relative to the noise level in the cell and can be used to determine the strength of the signal from the considered cell.
Channel Quality Indicator (CQI), which provides a measure of the quality of a received signal.
In addition to the above metrics, other measurements such as cell identity, beamforming quality, and channel state information may also be considered for signal strength measurements.

In case a UE considers a neighbour mobile cell as a mobile Cell bound with its serving mobile cell, it may record this information in a local Bound Cells table. For example, a list of bound mobile cells identifying one or more other mobile cells bound to the UE's serving cell may be provided or recorded at the UE 409. The list or table may include the cell identifiers of each of the bound mobile cells.

The advantage of having method 800 being implemented by a UE device lies in the ability for a UE device to autonomously identify bound mobile cells and perform cell reselection process accordingly, as defined in method 1200 of FIG. 12, (or Conditional Handover) without the need for additional signaling to be issued by mobile IAB nodes, as for methods 1000 of FIGS. 10 and 1100 of FIG. 11.

FIG. 9 is a flowchart of an example method 900 for sharing bound cell information by wireless communication device, according to one or more embodiments of the present invention.

For example, with reference to the IAB communication system shown in and described with respect to FIG. 4, the wireless communication device performing the method 900 of FIG. 9 may be mobile IAB node 460, 470 or 480. For example, method 900 is performed at IAB node associated with one or more mobile cells (i.e. a mobile IAB node) and is for use in facilitating network connectivity of a wireless communication device (such as a UE) in an IAB communication system. With respect to the example shown in FIG. 4, the IAB node performing method 900 may be mobile IAB node 460 associated with or managing mobile cell 4600.

The method 900 as shown in and described with respect to FIG. 9, may be performed by software elements and/or hardware elements. Thus, for example, the method as shown in and described with respect to FIG. 9 may be performed by an apparatus for the IAB node comprising one or more processing units configured to carry out the method. The mobile IAB node may be implemented in a communication device 1500 as shown in and described with reference to FIG. 15 with the method as shown in and described with respect to FIG. 15 being performed by one or more processing units, such as the central processing unit 1511.

Back to FIG. 9, the mobile IAB node 460 may detect or determine at step 901 that a mobile cell it is managing (mobile cell 4600) is bound with one or more other mobile cells, which may be managed by the mobile IAB node itself or by remote mobile IAB nodes, or a combination thereof. In the example shown in FIG. 4, mobile cells 4600, 4700 and 4800 managed by respective IAB nodes 460, 470 and 480 are bound to each other.

In one example, the detection step is based on information for identifying one or more other mobile cells to which at least one of the one or more mobile cells associated with the IAB node are bound, which information may include some bound cell configuration information. The bound cell configuration information may include at least one of: a configuration list of bound cell identifier(s), which provides the cell identifier for the mobile cells bound to each cell managed by the mobile IAB node; a configuration list of bound IAB node(s), which provides for each cell identifier in the configuration list of bound cell identifier(s) the identifier of the mobile IAB node managing the cell.

In one example, the bound cell configuration information may be received from the IAB donor node (e.g. IAB donor CU) managing or serving the mobile IAB node (such as IAB donor CU 401 for mobile IAB node 460). According to one aspect, the bound cell configuration information is received from the IAB donor CU through a BOUND CELL CONFIGURATION message 533, which is further described in FIG. 5.

In another example, the bound cell configuration information is a factory setting or is configured at the mobile IAB node 460 through an Operations, Administration and Maintenance (OAM) process. In such cases, the bound cell configuration information is not received from the IAB donor CU.

In case the mobile IAB node 460 detected that a mobile cell it is managing is bound with one or more other mobile cells, the mobile IAB node sends (e.g., to the UEs in its vicinity) information for identifying one or more other mobile cells as bound mobile cells to which at least one of the one or more mobile cells managed by the mobile IAB node 460 are bound. The information sent by the mobile IAB node 460 may include bound cell information sent in a BOUND CELL INFORMATION message 532 as described below. For example, the mobile IAB node 460 may broadcast bound cell information to the UEs in its vicinity, wherein the bound cell information includes at least one of: a bound cell group identifier, which provides an identifier of the group of bound mobile cells associated to the broadcasted bound cell information, a list of bound cell identifier(s), which provides the cell identifier for all or part of the one or more other mobile cells bound to the cell where the bound cell information is broadcasted; a list of bound IAB node(s), which provides for each cell identifier in the list of bound cell identifier(s) the identifier of the mobile IAB node managing the cell: the frequency for all or part of the one or more other mobile cells bound to the cell where the bound cell information is broadcasted (e.g., frequency information indicating the frequency for or used by each bound mobile cell of some or all of the one or more bound mobile cells to which the serving mobile cell is bound).

By doing so, a UE device may be informed about the bound mobile cells in its vicinity without having to perform any processing or computation at its own level. Moreover, as the bound mobile cells information may be broadcasted on a periodic basis, a UE device may get such information prior to initiate any cell connection process, hence allowing the UE device to preferably select a bound mobile cell when performing cell reselection as defined in method 1200 of FIG. 12 or CHO.

According to one aspect, the bound cell information is broadcasted through a BOUND CELL INFORMATION message 532, which is further described in FIG. 5.

According to another aspect, the bound cell information is broadcasted through a MOBILITY INFORMATION message 531, which is further described in FIG. 5.

FIG. 10 is a flowchart of an example method 1000 for sharing bound cell information by a wireless communication device, according to one or more embodiments of the present invention.

For example, with reference to the IAB communication system shown in and described with respect to FIG. 4, the wireless communication device performing the method 1000 of FIG. 10 may be the IAB donor CU 401. For example, method 1000 is performed at an IAB donor node (such as a IAB donor CU) of an IAB communication system and is for use in facilitating network connectivity of a wireless communication device (such as a UE) in the IAB communication system. With respect to the example shown in FIG. 4, the IAB donor node performing method 1000 may be IAB donor CU 401.

The method 1000 as shown in and described with respect to FIG. 10, may be performed by software elements and/or hardware elements. Thus, for example, the method as shown in and described with respect to FIG. 10 may be performed by an apparatus for the IAB donor node comprising one or more processing units configured to carry out the method. The IAB donor CU node may be implemented in a communication device 1500 as shown in and described with reference to FIG. 15 with the method as shown in and described with respect to FIG. 15 being performed by one or more processing units, such as the central processing unit 1511.

Back to FIG. 10, an IAB Donor CU may receive a connection setup request from a UE, such as UE 409, for a new serving cell managed by an IAB node, such as mobile cell 4600 managed by mobile IAB node 460. According to one aspect, the connection setup request is received through a CONNECTION SETUP REQUEST message 621, which is further described in FIG. 6. For example, a request for setting up a connection with a mobile cell associated with an IAB node managed by the IAB donor node (such as mobile cell 4700 managed by IAB node 470 which is managed by IAB donor CU 401) is received by the IAB donor CU 401 from the UE 409 (e.g. in a CONNECTION SETUP REQUEST message 621).

In case the cell requested by the UE 409 is bound to one or more cells, the IAB Donor CU 401 may provide or send to the UE 409 information for identifying one or more other mobile cells as bound mobile cells to which the mobile cell requested for connection is bound. For example, the information may include some bound cell information on the one or more cells which are bound to the requested cell in the CONNECTION SETUP REQUEST message 621. The bound cell information includes at least one of: a bound cell group identifier, which provides an identifier of the group of bound mobile cells associated to the broadcasted bound cell information, a list of bound cell identifier(s), which provides the cell identifier for all or part of the one or more other mobile cells bound to the cell where the bound cell information is broadcasted; a list of bound IAB node(s), which provides for each cell identifier in the list of bound cell identifier(s) the identifier of the mobile IAB node managing the cell: the frequency for all or part of the one or more other mobile cells bound to the cell where the bound cell information is broadcasted (e.g., frequency information indicating the frequency for/used by each bound mobile cell of some or all of the one or more bound mobile cells to which the serving mobile cell is bound).

According to one aspect, the bound cell information information is sent to the UE 409 through a CONNECTION SETUP RESPONSE message 622, which is further described in FIG. 6.

By performing method 1000, the bound cell information is advantageously passed by the IAB donor CU to the UE device during the connection process, hence avoiding to have some systematic signalling/periodic signalling as in method 900 of FIG. 9.

In one example, the IAB donor CU 401 determines the bound cell information based on some bound cell global configuration information.

In one example, the bound cell global configuration information may be received from the Core Network (CN) Access and Mobility Management Function (AMF) entity. According to one aspect, the bound cell global configuration information is received from the AMF through a GLOBAL CONFIGURATION message 534, which is further described in FIG. 5.

In another example, the bound cell global configuration information is a factory setting or is configured at IAB donor CU 401 through an Operations, Administration and Maintenance (OAM) process. In such case, the bound cell global configuration information is not received from the core network.

FIG. 11 is a flowchart of an example method 1100 for sharing bound cell information by a wireless communication device, according to one or more embodiments of the present invention.

For example, with reference to the IAB communication system shown in and described with respect to FIG. 4, the wireless communication device performing the method 1100 of FIG. 11 may be the IAB donor CU 401. For example, method 1100 is performed at an IAB donor node (such as a IAB donor CU) of an IAB communication system and is for use in facilitating network connectivity of a wireless communication device (such as a UE) in the IAB communication system. With respect to the example shown in FIG. 4, the IAB donor node performing method 1100 may be IAB donor CU 401.

The method 1100 as shown in and described with respect to FIG. 11, may be performed by software elements and/or hardware elements. Thus, for example, the method as shown in and described with respect to FIG. 11 may be performed by an apparatus for the IAB donor node comprising one or more processing units configured to carry out the method. The IAB donor CU node may be implemented in a communication device 1500 as shown in and described with reference to FIG. 15 with the method as shown in and described with respect to FIG. 15 being performed by one or more processing units, such as the central processing unit 1511.

Back to FIG. 11, an IAB donor CU 401 may manage, at step 1101, the connection establishment of a UE device, such as UE 409, to a mobile serving cell managed by a mobile IAB node, such as mobile cell 4600 managed by mobile IAB node 460.

Then, at step 1102, in case the mobile serving cell the UE connected to at step 1101 is bound to one or more mobile cells, or if at some point a new mobile cell is added to or a mobile cell is removed from the set or list of cells bound to the mobile serving cell the UE connected to at step 1101, the IAB donor CU 401 that manages the connection of the UE to the mobile serving cell provides or sends to the UE 409 information for identifying one or more other mobile cells as bound mobile cells to which the serving mobile cell is bound. For example, the information may include some bound cell information related to all or part of the cells which are bound to the mobile serving cell the UE 409 connected to at step 1101. The bound cell information may include at least one of: a bound cell group identifier, which provides an identifier of the group of bound mobile cells associated to the broadcasted bound cell information, a list of bound cell identifier(s), which provides the cell identifier for all or part of the one or more other mobile cells associated to the bound cell information, a list of bound IAB node(s), which provides for each cell identifier in the list of bound cell identifier(s) the identifier of the mobile IAB node managing the cell; a list of new bound cell identifiers, which provides the cell identifier for all or part of the new mobile cells which have been added to the list of bound cell identifier(s) of the bound cell group identifier considered in the bound cell information; a list of new bound IAB node(s), which provides for each cell identifier of the new mobile cells which have been added to the list of bound cell identifier(s) the identifier of the mobile IAB node managing the cell; a list of removed bound cell identifiers, which provides the cell identifier for each mobile cell which have been removed from the list of bound cell identifier(s) of the bound cell group identifier considered in the bound cell information, a list of removed bound IAB node(s), which provides for each cell identifier of the mobile cells which have been removed from the list of bound cell identifier(s) the identifier of the mobile IAB node managing the cell; the frequency for all or part of the one or more other mobile cells bound to the cell associated to the bound cell information (e.g., frequency information indicating the frequency for or used by each bound mobile cell of some or all of the one or more bound mobile cells to which the serving mobile cell is bound).

According to one aspect, the bound cell information is sent to the UE through a CONFIGURATION INFORMATION message 623, which is further described in FIG. 6.

In one example, the IAB donor CU 401 determines the bound cell information based on some bound cell global configuration information as discussed above with reference to FIG. 10.

By performing method 1100, the bound cell information is advantageously passed by the IAB donor CU to the UE device once the connection process is complete, hence avoiding to have some systematic signalling/periodic signalling as in method 900 of FIG. 9, while allowing dynamic update of the bound cell information, which would not be possible when the bound cell information sharing is limited to the connection setup process. Step 1101 is shown in dotted lines as the connection process may be completed and step 1102 may be performed immediately or soon after step 1101 or sometime after step 1101.

FIG. 12 is a flowchart of an example method 1200 for managing the connectivity to bound cells by a wireless communication device, or UE, according to one or more embodiments of the present invention.

For example, with reference to the IAB communication system shown in and described with respect to FIG. 4, the wireless communication device performing the method 1200 of FIG. 12 may be the UE 409. For example, method 1200 is performed at a UE and is for use in facilitating or managing network connectivity of the UE in an IAB communication system. The method 1200 as shown in and described with respect to FIG. 12, may be performed by software elements and/or hardware elements. Thus, for example, the method as shown in and described with respect to FIG. 12 may be performed by an apparatus for a UE comprising one or more processing units configured to carry out the method. The UE may be implemented in a communication device 1500 as shown in and described with reference to FIG. 15 with the method as shown in and described with respect to FIG. 15 being performed by one or more processing units, such as the central processing unit 1511.

Back to FIG. 12, a UE 409 may, at step 1201, determine its serving cell is bound to one or more other cells.

According to one aspect, the UE 409 determines its serving cell is bound to one or more other cells by performing the method 800 of FIG. 8b.

According to another aspect, the UE 409 determines its serving cell is bound to one or more other cells by receiving information from an IAB node. For example, the information may include the bound cell information sent in a BOUND CELL INFORMATION message 532, as defined in FIG. 5, which carries a non-empty Bound cell ID List in the bound cell information.

According to another aspect, the UE 409 determines its serving cell is bound to one or more other cells by receiving information from an IAB donor node (e.g. IAB donor CU). For example, the information may include the bound cell information sent in a CONNECTION SETUP RESPONSE message 622, as defined in FIG. 6, which carries a non-empty Bound cell ID List in the bound cell information.

According to another aspect, the UE 409 determines its serving cell is bound to one or more other cells by receiving information from an IAB donor node (e.g. IAB donor CU). For example, the information may include the bound cell information sent in a CONFIGURATION INFORMATION message 623, as defined in FIG. 6, which carries a non-empty Bound cell ID List in the bound cell information.

Then, at some point (step 1202), the UE 409 may turn from a connected state (e.g., NR RRC CONNECTED state as defined 3GPP TS 38.331 V17.1.0) to a non-connected state, such as an idle state (e.g., NR RRC_IDLE state as defined 3GPP TS 38.331 V17.1.0) or an inactive state (e.g., NR RRC_INACTIVE state as defined 3GPP TS 38.331 V17.1.0).

At a later stage (step 1203), the UE 409 identifies the need for cell reselection. This need may result from the link quality with its serving cell of the UE being below a predefined threshold.

Then, at step 1204, the UE 409 may check amongst the one or more neighbour cells it has discovered in its vicinity (e.g. one or more neighbour cells are discovered in the vicinity of or proximity to the UE 409 by the UE 409 performing a discovery procedure) if at least one of these discovered cells is a mobile cell bound to its former serving mobile cell (i.e., the cell the UE 409 was connected to when it turned from connected to non-connected state (e.g. inactive or idle mode)). After determining at least one of the discovered cells is a mobile cell bound to the serving mobile cell (i.e. the mobile cell that was serving the UE 409 when the UE 409 switched to a non-connected state), for example by checking whether any of the discovered cells are in the list/table of bound mobile cells provided at the UE 409, the UE 409 selects the bound mobile cell for cell reselection in preference to other discovered cells (i.e. other cells which are not bound mobile cells). In other words, the UE 409 ignores other discovered neighbouring cells for cell reselection when a discovered neighbouring cell is determined to be a bound mobile cell. In case one or more mobile bound cells are available, the UE 409 will select one of these bound mobile cells for performing cell reselection while ignoring the other neighbour cells which are not bound mobile cells.

Giving precedence to the reselection of a bound mobile cell allows preventing a UE onboard a vehicle (e.g. an onboard UE device) from connecting transiently to fixed or mobile cells that may come into range of the onboard UE device, hence preventing the UE device from experiencing potential sequences of disconnection/reconnection that would affect the service continuity at the UE device.

FIG. 13 is a flowchart of an example method 1300 for managing the conditional sharing of bound cell information by a wireless communication device, according to one or more embodiments of the present invention. For example, method 1300 is for managing the connectivity of a wireless communications device, such as a UE, to bound mobile cells (e.g. managing access of the wireless communication to bound mobile cells) according to one or more embodiments of the present invention.

For example, with reference to the IAB communication system shown in and described with respect to FIG. 4, the wireless communication device performing the method 1300 of FIG. 13 may be a UE device, such as UE device 409.

The method 1300 as shown in and described with respect to FIG. 13, may be performed by software elements and/or hardware elements. Thus, for example, the method as shown in and described with respect to FIG. 13 may be performed by an apparatus for a UE comprising one or more processing units configured to carry out the method. The UE node may be implemented in a communication device 1500 as shown in and described with reference to FIG. 15 with the method as shown in and described with respect to FIG. 15 being performed by one or more processing units, such as the central processing unit 1511.

Back to FIG. 13, a UE device 409 may select a mobile cell which is bound with one or more other mobile cells and may further try and connect to the selected mobile cell which is bound with one or more other mobile cells, as discussed in FIGS. 8, 9, 10 and 11. However, such connection may be conditioned by the UE being authorized to connect to the selected cell (step 1301).

For instance, a UE device may subscribe to a transportation pass which grants access to all the bound mobile cells of the local bus company. The UE device may also subscribe to a transportation pass which grants access to all the bound first-class mobile cells of the train it is onboard. In other words, the UE device may also subscribe to a transportation pass which grants access to all mobile cells associated with first class carriages of the train it is onboard. Alternatively, the UE device may only subscribe to a transportation pass which grants access to all mobile cells associated with carriages of another class (not including first class carriages) of the train it is onboard.

In one aspect, an IAB donor CU may be pre-configured or (re)configured by the core network (e.g. the AMF entity) with some Cell Access information. The cell access information (e.g. Cell Access information) identifies one or more of the mobile cells in the list of bound mobile cells to which the UE is not allowed access (i.e. is not authorized to access or not authorize to connect to).

According to one aspect, in case the Cell Access information indicates that the UE is not allowed to access the bound serving cell it is connected to, the UE device should disconnect from its current serving cell.

According to one aspect, in case the Cell Access information indicates that the UE is not allowed to access a given group of bound mobile cells, the UE device should not consider these cells for connecting to the network, as discussed in step 1001 of FIG. 10 (e.g. when selecting a new serving cell for a connection setup request) or step 1101 of FIG. 11, or in the context of cell reselection, as discussed in step 1204 of FIG. 12.

In one aspect, the UE device may be pre-configured or (re)configured with some Cell Access information, which would not allow the UE to get access to one or more set of bound mobile cells, wherein the Cell Access information includes at least one of: a list of restricted bound cell identifiers, which provides the cell identifier for the one or more bound mobile cells associated to the bound cell information which access is restricted for the UE device.

In one aspect, the UE may receive the Cell Access information in a UE CELL ACCESS CONFIGURATION message 625 defined in FIG. 6, from the Access and Mobility Management Function (AMF) Core Network entity either through the UE Configuration Update procedure (defined in 3GPP TS 23.501 v17.5.0) after registration procedure is completed, or by including the new Cell Access information in the Registration Accept or in the Registration Reject or in the Deregistration Request or in the Service Reject messages, defined in 3GPP TS 23.501 v17.5.0.

FIG. 14 is a flowchart of an example method 1400 for managing the connectivity of a wireless communications device, such as a UE device (e.g. UE), to bound cells by a network device, such as an IAB Donor node, according to one or more embodiments of the present invention.

For example, with reference to the IAB communication system shown in and described with respect to FIG. 4, the wireless communication device performing the method 1400 of FIG. 14 may be the IAB donor CU 401. For example, method 1400 is performed at an IAB donor node (e.g. IAB donor CU) and is for use in facilitating network connectivity of a wireless communication device (such as a UE) in an IAB communication system.

The method 1400 as shown in and described with respect to FIG. 14, may be performed by software elements and/or hardware elements. Thus, for example, the method as shown in and described with respect to FIG. 14 may be performed by an apparatus for the IAB donor node (e.g. IAB donor CU) comprising one or more processing units configured to carry out the method. The IAB donor CU node may be implemented in a communication device 1500 as shown in and described with reference to FIG. 15 with the method as shown in and described with respect to FIG. 15 being performed by one or more processing units, such as the central processing unit 1511.

Back to FIG. 14, the IAB donor CU 401 manages the connection of a new UE device, such as UE device 409, to a new serving cell managed by a mobile IAB node managed by the IAB donor CU 401 (step 1401). For example, the new serving cell may be mobile cell 4700 managed by or associated with IAB node 470 which is managed or controlled by IAB donor CU 401.

Then, at step 1402, the IAB donor CU 401 determines if the new serving cell is bound with one or more other cells based on some bound cell configuration information.

In one example, the bound cell configuration information may be received from the Core Network (CN) Access and Mobility Management Function (AMF) entity. According to one aspect, the bound cell configuration information is received from the AMF through a GLOBAL CONFIGURATION message 534, which is further described in FIG. 5.

In another example, the bound cell configuration information is a factory setting or is configured at mobile IAB donor CU 401 through an Operations, Administration and Maintenance (OAM) process. In such case, the bound cell configuration information is not received from the core network.

In case the IAB donor CU 401 determines that the new serving cell is bound with one or more other cells, the IAB donor CU negotiates some Handover (HO) or Conditional Handover (CHO) with the mobile IAB nodes (e.g. mobile IAB DUs) associated to all or part of the one or more other cells bound with the new serving cell.

In one aspect, the Handover (HO) or Conditional Handover (CHO) negotiation is performed through the sending of a MOBILITY SETUP REQUEST message 723 to the selected mobile IAB nodes (e.g. mobile IAB DUs) and the receiving of a MOBILITY SETUP RESPONSE message 724. The MOBILITY SETUP REQUEST message 723 and MOBILITY SETUP RESPONSE message 724 are further described in FIG. 7.

Eventually, the IAB donor CU sends to the UE device 409 a Handover (HO) or Conditional Handover (CHO) configuration for each of the selected bound mobile cells using a MOBILITY CONFIGURATION INFORMATION message 725, which is further described in FIG. 7.

As a UE connected to cell bound with one or more other cells is likely to move from its current serving cell to one of the cells bound to this serving cell, preconfiguring a conditional handover at a UE for said bound mobile cells would fasten the handover process, hence enhancing the service continuity at the UE level, while preventing UE device from connecting transiently to fixed or mobile cells that may come into range or proximity of the UE.

Referring now also to FIG. 5 which is a schematic and simplified diagram illustrating example message flows for managing of facilitating the connectivity of a UE to bound mobile cells in accordance with one or more embodiments of the invention.

According to an example, an Access and Mobility Management Function (AMF) entity of the core network (CN) 504 may provide a network device 503, such as the IAB Donor node 503 (e.g. IAB donor CU), with some bound cell global configuration information using a GLOBAL CONFIGURATION message 534. For example, the IAB donor node 503 may receive (from the core network or at factory set up) configuration information for identifying one or more lists of mobile cells that are bound to each other and that are managed by or associated with one or more IAB nodes managed by the IAB donor node 503.

According to one aspect, the configuration information such as the bound cell global configuration information includes, for all or part of the mobile IAB nodes served by the IAB donor CU, all or part of the following information:
Global Bound cell group ID List, which provides an identifier for each group of bound mobile cells, the bound mobile cells in a group being managed by or associated with one or more mobile IAB nodes managed by the IAB donor node 503;
Global Bound cell ID Configuration List, which provides the cell ID of the mobile cells bound to each other for each of the Bound cell groups in the Global Bound cell group ID List.
Global Bound IAB node Configuration List, which provides for each cell ID in the Global Bound cell ID Configuration List the identifier of the mobile IAB node associated with or managing the cell.

According to one aspect, the GLOBAL CONFIGURATION message 534 is the INITIAL CONTEXT SETUP REQUEST defined in the 3GPP TS 38.401.

Based on the bound cell global configuration information received from the AMF of the core network 504, the IAB donor node 503 (e.g. IAB donor CU) may derive for all or part of the mobile IAB nodes it is serving some bound cell configuration information that it will share with each considered served mobile IAB node using a BOUND CELL CONFIGURATION message 533. For example, based on the configuration information received at the IAB donor node 503, the IAB donor node 503 sends to at least one of the IAB nodes managed by the IAB donor node 503 information for identifying one or more bound mobile cells to which at least some of the one or more mobile cells associated with the at least one of the IAB nodes are bound.

According to one aspect, the bound cell configuration information sent by the IAB donor node 503 includes, all or part of the following information:
Bound cell group ID List, which provides an identifier for each group of bound mobile cells that includes at least one mobile cell managed by the mobile IAB node that receives the bound cell configuration information. In other words, it provides an identifier of a group of bound mobile cells which include the mobile cell associated to the bound cell configuration information.
Bound cell ID Configuration List, which provides the cell ID of the mobile cells bound to each other for each of the Bound cell groups in the Bound cell group ID List. In other words, it provides the cell ID of the mobile cells bound to the cell where the bound cell configuration is broadcasted;
Bound IAB node Configuration List, which provides for each cell ID in the Bound cell ID Configuration List the identifier of the mobile IAB node associated with or managing the cell.
Bound cell Frequency List, which provides some information related to the frequency for or used by each bound mobile cell of some or all of the one or more bound mobile cells bound to the cell where the bound cell configuration is broadcasted.

According to one aspect, the BOUND CELL CONFIGURATION message 533 is the GNB CU CONFIGURATION UPDATE message defined in the 3GPP TS 38.401.

According to one aspect, the BOUND CELL CONFIGURATION message 533 is the RRCReconfiguration message, defined in 3GPP TS 38.331.

Based on the bound cell configuration information received from the IAB donor node (e.g. IAB donor CU), the mobile IAB node 501 (such as IAB node 460) may derive for each of the mobile cells it is managing some bound cell information, which bound cell information it may further broadcast using a BOUND CELL INFORMATION message 532. For example, the IAB node 460 may send (e.g. via broadcast in the mobile cells associated with or managed by the IAB node) information for identifying one or more bound mobile cells to which at least some of the one or more mobile cells associated with or managed by the IAB node 460 are bound.

According to one aspect, the bound cell information carried in the BOUND CELL INFORMATION message 532 includes all or part of the following information:
Bound cell group ID, which provides an identifier of the group of bound mobile cells associated to the bound cell information. In other words, it provides an identifier of a group of bound mobile cells which include the mobile cell associated to the bound cell information.
Bound cell ID List, which provides the cell ID for one or more mobile cells bound to the mobile cell associated to the bound cell information. In other words, it provides the cell ID for the bound mobile cells belonging to the Bound cell group ID. In one example, the cell ID may be the Physical Cell Identity (PCI), and the Bound cell ID List may be a list or a range of PCIs.
Bound IAB node List, which provides for each cell ID in the Bound cell ID List the identifier of the mobile IAB node associated with or managing the cell.
Bound cell Frequency List, which provides some information related to the cell frequency for or used by all or part of the one or more other mobile cells bound to the cell associated to the bound cell information.

According to one aspect, the BOUND CELL INFORMATION message 532 is one of the SIB1 message, SIB3 message or SIB4 message, as defined in 3GPP TS 38.331.

In one aspect of the invention, the Bound cell ID List may also be referred to as intraFreqBoundCellList or may be part of some broader intraFreqMobileCellList information element listing intra-frequency mobile cells with specific cell re-selection parameters, when carried in a SIB3 message.

In one aspect of the invention, the Bound cell ID List may also be referred to as interFreqBoundCelIList or may be part of some interFreqMobileCellList information element listing intra-frequency mobile cells with specific cell re-selection parameters, when carried in SIB4 message.

In addition to the BOUND CELL INFORMATION message 532, the mobile IAB node 501 may broadcast over each of the mobile cells it is managing some mobility indication, which indicates that the cell where the BOUND CELL INFORMATION message 532 is broadcasted actually a mobile cell.

According to one aspect, the MOBILITY INFORMATION message 531 is the SIB1 message as defined in 3GPP TS 38.331.

Referring now also to FIG. 6 which is a schematic and simplified diagram illustrating example message flows for managing or facilitating the connectivity of a UE to bound mobile cells in accordance with one or more embodiments of the invention.

According to an example, a UE 602 may request the connection to a mobile IAB cell managed by or associated with mobile IAB node 601 by sending a CONNECTION SETUP REQUEST message 621 to the IAB Donor node (e.g. IAB Donor CU 603) which is serving or managing mobile IAB node 601.

According to one aspect, the CONNECTION SETUP REQUEST message 621 is the RRCSetupRequest message defined in 3GPP TS 38.331.

The IAB Donor CU 603 may respond to the received connection request by issuing a CONNECTION SETUP RESPONSE message 622, which may include some bound cell information to inform the UE device 602 about the one or more mobile cells which are bound with the mobile cell requested for connection in the CONNECTION SETUP REQUEST message 621. For example, the IAB donor CU 603 sends a response including information, such as the bound cell information, for identifying one or more bound mobile cells to which the mobile cell requested for connection is bound.

According to one aspect, the bound cell information carried in the CONNECTION SETUP REQUEST message 621 includes all or part of the following information:
Bound cell group ID, which provides an identifier of the group of bound mobile cells associated to the broadcasted bound cell information. In other words, it provides an identifier of a group of bound mobile cells which include the mobile cell to which the UE device is trying to connect;
Bound cell ID List, which provides the cell ID for all or part of the one or more other mobile cells bound to the cell to which the UE device is trying to connect;
Bound IAB node List, which provides for each cell ID in the Bound cell ID List the identifier of the mobile IAB managing the cell.
Bound cell Frequency List, which provides some information related to the cell frequency for or used by all or part of the one or more other mobile cells bound to the cell associated to the bound cell information.

According to one aspect, the CONNECTION SETUP RESPONSE message 622 is the RRCSetup message defined in 3GPP TS 38.331.

According to an example, the UE device 602 may further try to register to the Core Network (CN) Access and Mobility Management Function (AMF) entity of the core network 604, which may then provide the UE device 602, with some Cell Access information using a CELL ACCESS CONFIGURATION message 625.

According to one aspect, the Cell Access information includes all or part of the following additional information:
Restricted Bound cell ID List, which provides the cell ID for the one or more bound mobile cells which access is restricted to the UE device;
Restricted Bound cell group ID, which provides an identifier of the group of bound mobile cells which access is restricted to the UE device.
Restricted Bound IAB node List, which provides for each cell ID in the Restricted Bound cell ID List the identifier of the mobile IAB node managing or associated with the one or more bound mobile cells which access is restricted to the UE device.
Restricted Bound cell Frequency List, which provides some information related to the cell frequency for or used by all or part of the one or more other mobile cells bound to the cell associated to the Cell Access information which access is restricted to the UE device (e.g., frequency information indicating the frequency for each bound mobile cell of some or all of the one or more mobile cells in the list of bound mobile cells to which the wireless communication device is not allowed access).

In one aspect, the Cell Access information may also include a Closed Access Group (CAG) identifier, which identifies a group of subscribers who are permitted to access one or more CAG cells associated to the CAG, as defined in 3GPP TS 23.501 v17.5.0.

In one aspect of the invention, the Bound cell ID List may also be the intraFreqCAG-CellList information element listing intra-frequency neighbouring CAG cells as defined in TS 38.331, when carried in a SIB3 message.

In one aspect of the invention, the Bound cell ID List may also be interFreqCAG-CellList information element listing inter-frequency neighbouring CAG cells as defined in TS 38.331, when carried in a SIB4 message.

In one aspect, an IAB donor CU 603 may wish to inform the UE device 602 about the one or more mobile cells which are bound with the mobile cell the UE device is connected to sending some bound cell information to the UE 602 through a CONFIGURATION INFORMATION message 623.

In one aspect, the IAB donor CU 603 sends some bound cell information to the UE 602 through both the CONNECTION SETUP RESPONSE message 622, as part of the UE connection setup process, and the CONFIGURATION INFORMATION message 623.

In one aspect, the IAB donor CU 603 sends some bound cell information to the UE 602 through the CONNECTION SETUP RESPONSE message 622 only.

In one aspect, the IAB donor CU 603 sends some bound cell information to the UE 602 through the CONFIGURATION INFORMATION message 623 only.

In one aspect, the IAB donor CU 603 may also use the sending of some bound cell information through CONFIGURATION INFORMATION message 623 to provide the UE 602 with an updated list of the one or more mobile cells which are bound with the mobile cell it is connected to or to inform the UE 602 about some new mobile cell(s) which have been added to the list of the one or more mobile cells which are bound with the mobile cell it is connected to (e.g. the serving mobile cell). For example, the information sent in the CONFIGURATION INFORMATION message 623 may include update information including information for identifying one or more new mobile cells which have added as bound mobile cells and/or information for identifying one or more new mobile cells which have been removed as bound mobile cells.

According to one aspect, the bound cell information carried in the CONFIGURATION INFORMATION message 623 includes all or part of the following information:
Bound cell group ID, which provides an identifier of the group of bound mobile cells associated to the bound cell information. In other words, it provides an identifier of a group of bound mobile cells which include the mobile cell to which the UE device is connected to;
Bound cell ID List, which provides the cell ID for all or part of the one or more other mobile cells associated to the bound cell information. In other words, it provides the cell ID for all or part of the one or more other mobile cells which are bound to the mobile cell to which the UE device is connected to;
Bound IAB node List, which provides for each cell ID in the Bound cell ID List the identifier of the mobile IAB managing the cell;
New Bound cell ID List, which provides the cell ID for all or part of the new mobile cells which have been added to the Bound cell ID List of the Bound cell group ID considered in the bound cell information.
Bound cell Frequency List, which provides some information related to the cell frequency for or used by all or part of the one or more other mobile cells bound to the cell associated to the bound cell information.

Referring now also to FIG. 7 which is a schematic and simplified diagram illustrating example message flows for managing the connectivity of a UE to bound mobile cells in accordance with one or more embodiments of the invention.

According to an example, UE 702 initiates the connection process to a mobile cell managed by mobile IAB DU 701 by sending a CONNECTION SETUP REQUEST message 721 to IAB Donor node (e.g. IAB donor CU 703).

IAB Donor CU 703 may further accept the UE connection to the cell requested through CONNECTION SETUP REQUEST message 721 by sending back a CONNECTION SETUP RESPONSE message 722 to UE 702.

According to one aspect, the CONNECTION SETUP REQUEST message 721 is the RRCSetupRequest message defined in 3GPP TS 38.331.

According to one aspect, the CONNECTION SETUP RESPONSE message 722 is the RRCSetup message defined in 3GPP TS 38.331.

In case the IAB Donor CU 703 determines that the cell requested for connection by UE 702 (for instance a mobile cell managed by IAB node 701) through the CONNECTION SETUP REQUEST message 721 is bound to one or more other mobile cells, the IAB donor CU 703 may negotiate conditional handover (CHO) of UE 702 with the IAB nodes associated with or managing all or part of the one or more other mobile cells bound to the cell requested for connection by UE 702.

In case the bound mobile cell considered for CHO negotiation, also referred to as the target cell for CHO, belongs to an IAB node 704 served or managed by the same IAB donor CU 703 as the IAB node 701 serving or managing the cell requested for connection by UE 702, the MOBILITY SETUP REQUEST message 723a is used by the IAB donor CU 703 to create a UE context and setup one or more data bearers and request intra-gNB conditional handover for the target cell considered for CHO. The MOBILITY SETUP RESPONSE message 724a is used by the IAB donor CU 703 to confirm the reception of the MOBILITY SETUP REQUEST message 723a. The MOBILITY SETUP RESPONSE message 724a may include the cell ID of the target cell for CHO. For example, the IAB donor node (e.g. IAB donor CU 703) may send a setup request (e.g. MOBILITY SETUP REQUEST message 723a) for requesting CHO to each of the one or more IAB nodes for at least some of the one or more other mobile cells bound to the cell requested for connection. The IAB donor node (e.g. IAB donor CU 703) may receive a setup response (e.g. MOBILITY SETUP RESPONSE message 724a) acknowledging receipt of the setup request. The setup request may include information relating to or associated with the UE 702 to create a UE context and setup one or more data bearers at the IAB node receiving the setup request. The information may include identification information for identifying the UE 702 (e.g. UE ID), authentication information for use in authenticating the UE 702, security context information (e.g. security parameters such as security key, UE security capabilities), measurement configuration, radio configuration (e.g. UE radio capability), information about bearers. The setup response from the IAB node 704 may include identification information (e.g. the cell ID) of the bound mobile cell managed by or associated with the IAB node 704 which is a target cell for CHO. The setup response may also include information relating to the Data Radio Bearers (DRB)/Signalling Radio Bearers (SRB)/BH RLC channels successfully established or failed to be establish.

According to one aspect, the MOBILITY SETUP REQUEST message 723a is the UE CONTEXT SETUP REQUEST message defined in 3GPP TS 38.401.

According to one aspect, the MOBILITY SETUP RESPONSE message 724a is the UE CONTEXT SETUP RESPONSE message defined in 3GPP TS 38.401.

In case the bound mobile cell considered for CHO negotiation, also referred to as the target cell for CHO, belongs to an IAB node 704 served or managed by an IAB donor node (e.g. IAB donor CU 705) different from the IAB donor CU 703 that serves or manages the IAB node 701 serving the cell requested for connection by UE 702, the MOBILITY SETUP REQUEST message 723b is used by the IAB donor CU 703 to request CHO for the target cell. Some admission control may be performed at the IAB donor CU 705 as a result of which the IAB donor CU 705 determines whether to accept or reject CHO for the target cell. The MOBILITY SETUP RESPONSE message 724b is used by the IAB donor CU 705 to acknowledge the request for conditional handover received through MOBILITY SETUP REQUEST message 723b based on the result of the admission control process. For example, in the case the IAB donor node (e.g. IAB donor CU 703) determines the mobile cell requested for connection is bound to one or more other mobile cells and at least one IAB node associated with at least some of the one or more other mobile cells is managed by another IAB donor node (e.g. IAB donor CU 705), the IAB donor CU 703 negotiates Conditional Handover, CHO, with the another IAB donor CU 705. The IAB donor CU 703 may send a setup request (e.g. MOBILITY SETUP REQUEST message 723b) for requesting CHO to the another IAB donor node. The IAB donor node (e.g. IAB donor CU 703) may receive a setup response (e.g. MOBILITY SETUP RESPONSE message 724b) acknowledging receipt of the setup request. The setup request may include information relating to or associated with the UE 702 to create a UE context and setup one or more data bearers at the IAB node associated with the bound mobile cell. The information may include identification information for identifying the UE 702 (e.g., UE ID), authentication information for use in authenticating the UE 702, security context information (e.g. security parameters such as security key, UE security capabilities), measurement configuration, radio configuration (e.g. UE radio capability), information about bearers. The setup response from the IAB donor node (e.g. IAB donor CU 705) may include identification information (e.g. the cell ID) of the bound mobile cell managed by or associated with the IAB node 704 which is a target cell for CHO. The setup response may also indicate whether the request for conditional handover has been accepted or rejected by the IAB donor CU 705. The setup response may also include information relating to the Data Radio Bearers (DRB)/Signalling Radio Bearers (SRB)/BH RLC channels successfully established or failed to be establish.

According to one aspect, the MOBILITY SETUP REQUEST message 723b is the HANDOVER REQUEST message defined in 3GPP TS 38.300.

According to one aspect, the MOBILITY SETUP RESPONSE message 724b is the HANDOVER ACKNOWLEDGE message defined in 3GPP TS 38.300.

Upon reception of either the MOBILITY SETUP RESPONSE message 723a or the MOBILITY SETUP RESPONSE message 724a, the IAB donor CU 703 may eventually send to the UE 702 a MOBILITY CONFIGURATION INFORMATION message 725 which includes configuration parameters (such as data bearer information, cell ID of the target cell, frequencies used by the target cell) to be used by UE device 702 for performing conditional handover with the target cell for which the IAB donor CU 703 negotiated a CHO.

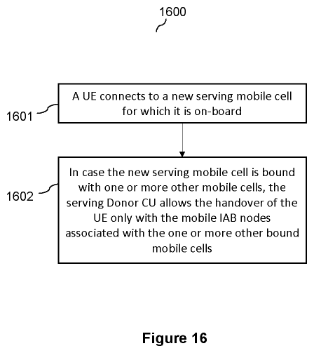

FIG. 16 is a flowchart of an example method 1600 for managing the connectivity of a wireless communications device, such as a UE device (e.g., UE), to bound cells by a network device, such as an IAB Donor node, or donor CU, according to one or more embodiments of the present invention.

For example, with reference to the IAB communication system shown in and described with respect to FIG. 4, the network device performing the method 1600 of FIG. 16 may be the IAB donor CU 401. For example, method 1600 is performed at an IAB donor node (e.g. IAB donor CU) and is for use in facilitating network connectivity of a wireless communication device (such as a UE) in an IAB communication system.

The method 1600 as shown in and described with respect to FIG. 16, may be performed by software elements and/or hardware elements. Thus, for example, the method as shown in and described with respect to FIG. 16 may be performed by an apparatus for the IAB donor node (e.g., IAB donor CU) comprising one or more processing units configured to carry out the method. The IAB donor CU node may be implemented in a communication device 1500 as shown in and described with reference to FIG. 15 with the method as shown in and described with respect to FIG. 15 being performed by one or more processing units, such as the central processing unit 1511.

Back to FIG. 16, the IAB donor CU 401 manages the connection of a new UE device, such as UE device 409, to a new serving cell managed by a mobile IAB node managed by the IAB donor CU 401 (step 1601). For example, the new serving cell may be mobile cell 4700 managed by or associated with IAB node 470 which is managed or controlled by IAB donor CU 401 (e.g. the serving donor CU). Then the IAB donor CU 401 may determine that the new UE device is on-board with the mobile IAB-node managing the mobile IAB-cell 4700 (e.g., the new serving cell). In one aspect, the IAB donor CU 401 determines by itself the on-board status of the new UE device based at least on some measurements reporting received from the new UE device 409. In another aspect, the new UE device 409 determines by itself its on-board status based at least on some signal strength measurements with said new serving cell and further notifies the IAB donor CU 401 of its on-board status.

Then, the IAB donor CU 401 determines if the new serving cell is bound with one or more other cells based on some bound cell configuration information, as previously discussed in FIG. 14.

In one aspect, in case the new serving cell is bound with one or more other cells, the serving Donor CU (e.g. IAB donor CU 401) may allow the handover of the UE (e.g. UE device 409) only with the one or more mobile IAB nodes associated with the one or more bound mobile cells as long as the new UE device remains on-board with the mobile IAB-node managing the new serving cell (step 1602). In other words, the serving Donor CU may not perform the handover of the UE with any IAB node or base station that is not associated with the one or more bound mobile cells as long as the new UE device remains on-board with the mobile IAB-node managing the new serving cell.

FIG. 15 shows a schematic representation of an example communication device (apparatus) or station, in accordance with one or more example embodiments of the present disclosure.

The communication device 1500 may be a device such as a micro-computer, a workstation or a light portable device. The communication device 1400 may comprise a communication bus 1513 to which there are connected:
a central processing unit 1511, such as a microprocessor, denoted CPU. The central processing unit 1511 may be a single processing unit or processor or may comprise two or more processing units or processors carrying out the processing required for the operation of the communication device 1500. The number of processors and the allocation of processing functions to the central processing unit 1511 is a matter of design choice for a skilled person;
memory for storing data and computer programs containing instructions for the operation of the communication device 1500. The computer programs may contain a number of different program elements (modules) or sub-routines containing instructions for a variety of operations and for implementing the methods in accordance with one or more embodiments of the invention; and
at least one communication interface 1502 for communicating with other devices or nodes in a wireless communication system, such as the wireless communication system of FIG. 1 or FIG. 4. The at least one communication interface 1502 may be connected to the radio communication network 1503, such as a wireless communication network for 5G NR (e.g. according to the release 16 and/or subsequent releases), over which digital data packets or frames or control frames are transmitted. The frames are written from a FIFO sending memory in RAM 1512 to the communication interface for transmission or are read from the communication interface for reception and writing into a FIFO receiving memory in RAM 1512 under the control of a software application running in the CPU 1511.

Each of a donor CU, a donor DU, an IAB node and a UE may comprise such a communication device 1500.

The memory may include:
a read only memory 1507, denoted ROM, for storing computer programs for implementing the methods in accordance with one or more embodiments of the invention;
a random-access memory 1512, denoted RAM, for storing the executable code of methods according to one or more embodiments of the invention as well as the registers adapted to record variables and parameters necessary for implementing methods according to one or more embodiments of the invention.

Optionally (and according to function of the communication device), the communication device 1500 may also include the following components:
a data storage means 1504 such as a hard disk, for storing computer programs for implementing methods according to one or more embodiments of the invention;
a disk drive 1505 for a disk 1506, the disk drive being adapted to read data from the disk 1506 or to write data onto said disk;
a screen 1509 for displaying decoded data and/or serving as a graphical interface with the user, by means of a keyboard 1510 or any other input/output means.

In an example arrangement, the communication bus provides communication and interoperability between the various elements included in the communication device 1500 or connected to it. The representation of the bus is not limiting and in particular, the central processing unit is operable to communicate instructions to any element of the communication device 1500 directly or by means of another element of the communication device 1500.

The disk 1506 may optionally be replaced by any information medium such as for example a compact disk (CD-ROM), rewritable or not, a ZIP disk, a USB key or a memory card and, in general terms, by an information storage means that can be read by a microcomputer or by a microprocessor, integrated or not into the communication device, possibly removable and adapted to store one or more programs whose execution enables a method according to embodiments of the invention to be implemented.

The executable code may optionally be stored either in read only memory 1507, on the hard disk 1504 or on a removable digital medium such as for example a disk 1506 as described previously. According to an optional variant, the executable code of the programs can be received by means of the communication network 1503, via the interface 1502, in order to be stored in one of the storage means of the communication device 1500, such as the hard disk 1504, before being executed.

The central processing unit 1511 may be adapted to control and direct the execution of the instructions or portions of software code of the program or programs according to embodiments of the invention, which instructions are stored in one of the aforementioned storage means. On powering up, the program or programs that are stored in a non-volatile memory, for example on the hard disk 1504 or in the read only memory 1507, are transferred into the random-access memory 1512, which then contains the executable code of the program or programs, as well as registers for storing the variables and parameters necessary for implementing the invention.

In an example implementation, the communication device (apparatus) is a programmable device/apparatus which uses software to implement the invention. Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “central processing unit” as used herein may refer to any of the foregoing structure or any other structure suitable for implementation of the techniques described herein. However, alternatively, the present invention may be implemented in hardware (for example, in the form of an Application Specific Integrated Circuit or ASIC or other logic element).

While the present invention has been described with reference to examples and embodiments, it is to be understood that the invention is not limited to the disclosed examples and embodiments. It will be appreciated by those skilled in the art that various changes and modification might be made without departing from the scope of the invention, as defined in the appended claims. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

In the preceding embodiments, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave may be included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Further information relating to the disclosure as set out above is set out in the following description:

In RAN2 #122 meeting, based on 3GPPP R2-2306871 document, RAN2 identified the need to help a UE that is physically on a moving vehicle but not camped on its mobile IAB-cell yet (i.e., the UE is camped on a stationary cell) to identify a neighbour mobile IAB-cell, prioritize this mobile IAB-cell (frequency and cell) and “pull” the UE into this mobile IAB-cell. This is also referred to as “Problem 1” in RAN2 #122.

Also, in order to prevent service discontinuity that would result from the onboard UE device camped on a mobile IAB cell disconnecting from this mobile IAB cell to transiently camp to a stationary cell (managed by a gNB or a fixed IAB node) or to some other mobile IAB cell passing by in the vicinity, an onboard UE in IDLE/INACTIVE state may no longer perform any cell reselection and associated neighbouring cell measurements as long as it remains onboard for the considered mobile IAB node. This is related to “Problem 2” identified in RAN2 #122 and discussed in 3GPPP R2-2306871 document.

In relation with both Problem 1 and Problem 2, RAN2 acknowledged in RAN2 #122 that a UE in IDLE/INACTIVE state may prioritize a highest ranked cell at a frequency, if it broadcasts a mIAB-cell type indicator in SIB1 for cell reselection. The UE may use the SIB4 assistance information to identify the presence of such mobile IAB-cell(s), if broadcasted. A SIB4 assistance information may include mIAB-cell frequencies. FFS on stage-2/3 to clarify the UE in problem 1 and 2.

Therefore, when considering problem 1 and Problem 2, it may be proposed that an onboard UE in IDLE/INACTIVE state may limit cell reselection and associated neighbouring cell measurements to mobile IAB cells which frequency is specified in SIB4 assistance information.

### Clauses Setting Out Further Aspects and Embodiments

1. A method, performed at a wireless communication device, for use in facilitating network connectivity of the wireless communication device in an Integrated Access and Backhaul, IAB, communication system, comprising:
   determining whether a serving mobile cell serving the wireless communication device is bound to one or more other mobile cells.
2. The method of clause 1, wherein determining comprises: upon identifying a cell neighbouring the serving mobile cell is a mobile cell, starting a timer;
   determining the identified mobile cell is a bound mobile cell bound to the serving mobile cell when one or more certain conditions are met on expiry of the timer.
3. The method of clause 2, further comprising:
   receiving, from the cell neighbouring the serving mobile cell, indication information indicating the cell is a mobile cell,
      wherein the cell neighbouring the serving mobile cell is identified as a mobile cell based on the received indication information.
4. The method of clause 2 or clause 3, wherein the certain conditions include one or more of:
   signals associated with the identified mobile cell are still detected on expiry of the timer;
   signal strength measurements of signals associated with the identified mobile cell are above a certain threshold during a time period between starting of the timer and expiry of the timer;
   signal strength measurements of signals associated with the identified mobile cell are between first and second certain thresholds during a time period between starting of the timer and expiry of the timer.
5. The method of clause 1, further comprising receiving, from an IAB node, information for identifying one or more other mobile cells as bound mobile cells to which the serving mobile cell is bound,
   wherein determining comprises determining whether the serving mobile cell serving the wireless communication device is bound to one or more other mobile cells based on the received information.
6. The method of clause 5, wherein the information includes at least one of:
   a group identifier for identifying a group of bound mobile cells associated with the one or more bound mobile cells to which the serving mobile cell is bound;
   a list of one or more identifiers of the one or more bound mobile cells to which the serving mobile cell is bound;
   a list of one or more identifiers of one or more mobile IAB nodes which are associated with the one or more bound mobile cells to which the serving mobile cell is bound;
   frequency information indicating the frequency for each bound mobile cell of some or all of the one or more bound mobile cells to which the serving mobile cell is bound.
7. The method of clause 1, further comprising:
   sending, to an IAB donor node, a request for setting up a connection with a mobile cell associated with an IAB node managed by the IAB donor node;
   receiving, from the IAB donor node, a response including information for identifying one or more other mobile cells as bound mobile cells to which the mobile cell requested for connection is bound.
8. The method of clause 7, wherein in the case where a connection has been established with the mobile cell, the mobile cell is the serving mobile cell serving the wireless communication device,
   wherein determining comprises determining whether the serving mobile cell serving the wireless communication device is bound to one or more other mobile cells based on the information included in the received response.
9. The method of clause 7 or clause 8, wherein the information includes at least one of:
   a group identifier for identifying a group of bound mobile cells associated with the one or more bound mobile cells to which the mobile cell requested for connection is bound;
   a list of one or more identifiers of the one or more bound mobile cells to which the mobile cell requested for connection is bound;
   a list of one or more identifiers of one or more mobile IAB nodes which are associated with the one or more bound mobile cells to which the mobile cell requested for connection is bound;
   frequency information indicating the frequency for each bound mobile cell of some or all of the one or more bound mobile cells to which the mobile cell requested for connection is bound.
10. The method of clause 1 or any one of clauses 7 to 9, further comprising:
   receiving, from an IAB donor node managing a connection between the wireless communication device and the serving mobile cell, information for identifying one or more other mobile cells as bound mobile cells to which the serving mobile cell is bound,
   wherein determining comprises determining whether a mobile cell neighbouring the serving mobile cell serving the wireless communication device is bound to the serving mobile cell based on the received information.
11. The method of clause 10, wherein the information includes at least one of:
   a group identifier for identifying a group of bound mobile cells associated with the one or more bound mobile cells to which the serving mobile cell is bound;
   a list of one or more identifiers of the one or more bound mobile cells to which the serving mobile cell is bound;
   a list of one or more identifiers of one or more mobile IAB nodes which are associated with the one or more bound mobile cells to which the serving mobile cell is bound;
   frequency information indicating the frequency for each bound mobile cell of some or all of the one or more bound mobile cells to which the serving mobile cell is bound.
12. The method of clause 10 or clause 11, wherein the information received from the IAB donor node includes update information including at least one of information for identifying one or more new mobile cells which have been added as bound mobile cells and information for identifying one or more mobile cells which have been removed as bound mobile cells.
13. The method of clause 12, wherein the update information includes at least one of:
   a list of one or more identifiers of the one or more new mobile cells added as bound mobile cells;
   a list of one or more identifiers of one or more mobile IAB nodes which are associated with the one or more new mobile cells added as bound mobile cells;
   a list of one or more identifiers of the one or more mobile cells removed as bound mobile cells;
   a list of one or more identifiers of one or more mobile IAB nodes which are associated with the one or more mobile cells removed as bound mobile cells.
14. The method of any one of clauses 7 to 13, further comprising receiving, from the IAB donor node, configuration information for Handover, HO, or Conditional Handover, CHO for at least some of the one or more bound mobile cells.
15. The method of clause 14, further comprising:
   after determining conditions for conditional handover to at least one of the one or more bound mobile cells are met, performing handover to the at least one bound mobile cell.
16. The method of any one of the preceding clauses, wherein a list of bound mobile cells identifying one or more other mobile cells bound to the serving mobile cell is provided at the wireless communication device based on determining the serving mobile cell serving the wireless communication device is bound to one or more other mobile cells.
17. The method of clause 16, further comprising receiving cell access information identifying one or more of the mobile cells in the list of bound mobile cells as restricted cells to which the wireless communication device is not allowed access.
18. The method of clause 17, wherein the cell access information includes at least one of:
   one or more identifiers for each of the one or more of the mobile cells in the list of bound mobile cells to which the wireless communication device is not allowed access;
   a group identifier for identifying a group of bound mobile cells to which the wireless communication device is not allowed access;
   one or more identifiers of one or more mobile IAB nodes which are associated with the one or more of the mobile cells in the list of bound mobile cells to which the wireless communication device is not allowed access;
   frequency information indicating the frequency for each bound mobile cell of some or all of the one or more mobile cells in the list of bound mobile cells to which the wireless communication device is not allowed access.
19. The method of clause 17 or clause 18, further comprising, in the case where the serving mobile cell is identified by the received cell access information as a mobile cell to which the wireless communication device is not allowed access, disconnecting from the serving mobile cell.
20. The method of any one of the preceding clauses, further comprising:
   in a case where the wireless communication device determines a serving mobile cell serving the wireless communication device is bound to one or more other mobile cells and in a case where the wireless communication device is in a RRC non-connected state, determining a need for cell reselection;
   after determining a need for cell reselection, determining whether at least one neighbouring cell of one or more neighbouring cells discovered by the wireless communication device is one of the one or more bound mobile cells bound to the serving mobile cell;
   after determining at least one neighbouring cell is a bound mobile cell, performing cell reselection to the bound mobile cell.
21. The method of any one of clauses 17 to 19, further comprising:
   in a case where the wireless communication device determines a serving mobile cell serving the wireless communication device is bound to one or more other mobile cells and in a case where the wireless communication device is in a RRC non-connected state, determining a need for cell reselection;
   after determining a need for cell reselection, determining whether at least one neighbouring cell of one or more neighbouring cells discovered by the wireless communication device is one of the one or more bound mobile cells bound to the serving mobile cell;
   after determining at least one neighbouring cell is a bound mobile cell, determining whether the wireless communication device is allowed access to the bound mobile cell based on cell access information;
   after determining the wireless communication device is allowed access to the bound mobile cell, performing cell reselection to the bound mobile cell.
22. The method of clause 21, further comprising after determining the wireless communication device is not allowed access to the bound mobile cell, not performing cell
reselection to the bound mobile cell. 23. The method of any one of clauses 20 to clause 22, wherein determining whether at least one neighbouring cell of one or more neighbouring cells discovered by the wireless communication device is one of the one or more bound mobile cells bound to the serving mobile cell comprises:
   checking whether any of the one or more discovered neighbouring cells corresponds to one of the one or more bound mobile cells bound to the serving mobile cell;
   in the case where at least one neighbouring cell does correspond to one of the one or more bound mobile cells bound to the serving mobile cell, selecting the at least one neighbouring cell corresponding to the bound mobile cell for performing cell reselection.
24. The method of clause 23, wherein a list of bound mobile cells identifying one or more other mobile cells bound to the serving mobile cell is provided at the wireless communication device,
   wherein checking whether any of the one or more neighbouring cells discovered by the wireless communication device corresponds to one of the one or more bound mobile cells comprises checking whether any of the one or more discovered neighbouring cells corresponds to a bound mobile cell in the list of bound mobile cells.
25. The method of any one of clauses 20 to 24, wherein in the case where more than one neighbouring cells are determined to be bound mobile cells, selecting one of the more than one neighbouring cells for cell reselection.
26. The method of any one of the preceding clauses, wherein movement of the wireless communication device is related to movement of the serving mobile cell.
27. The method of any one of the preceding clauses, wherein an IAB node associated with the serving mobile cell is mounted on a vehicle, the IAB node or another IAB node controlling the mobile cell determined to be bound to the serving mobile cell is mounted on the vehicle and the wireless communication device is on board the vehicle.
28. A method for use in facilitating network connectivity of a wireless communication device in an Integrated Access and Backhaul, IAB, communication system including an IAB node associated with one or more mobile cells, the method at the IAB node comprising:
   sending information for identifying one or more other mobile cells as bound mobile cells to which at least one of the one or more mobile cells are bound.
29. The method of clause 28, further comprising determining the one or more mobile cells associated with the IAB node are bound to one or more other mobile cells as bound mobile cells,
   wherein sending comprises sending information for identifying one or more other mobile cells as bound mobile cells to which at least one of the one or more mobile cells are bound after determining the one or more mobile cells associated with the IAB node are bound to the one or more other mobile cells.
30. The method of clause 28 or clause 29, further comprising:
   receiving, from an IAB donor node managing the IAB node, information for identifying one or more other mobile cells to which at least one of the one or more mobile cells associated with the IAB node are bound,
   wherein sending comprises sending information for identifying one or more bound mobile cells to which the at least one of the one or more mobile cells are bound based on the received information.
31. The method of clause 30, wherein the received information includes at least one of:
   one or more group identifiers, each group identifier for identifying a group of bound mobile cells that include at least one mobile cell associated with the IAB node;
   for each group of bound mobile cells that include at least one mobile cell associated with the IAB node, a list of one or more identifiers of the one or more bound mobile cells in the group;
   for each group of bound mobile cells that include at least one mobile cell associated with the IAB node, a list of one or more identifiers of one or more mobile IAB nodes which are associated with the one or more bound mobile cells in the group;
   for each group of bound mobile cells that include at least one mobile cell associated with the IAB node, frequency information indicating the frequency for each bound mobile cell of some or all of the one or more bound mobile cells in the group.
32. The method of any one of clauses 30 to 31, wherein the information sent, by the IAB node, includes at least one of:
   a group identifier for identifying a group of bound mobile cells associated with one or more bound mobile cells to which at least one of the one or more mobile cells are bound;
   a list of one or more identifiers of the one or more bound mobile cells to which at least one of the one or more mobile cells are bound;
   a list of one or more identifiers of one or more mobile IAB nodes which are associated with the one or more bound mobile cells to which at least one of the one or more mobile cells are bound;
   frequency information indicating the frequency for each bound mobile cell of some or all of the one or more bound mobile cells to which at least one of the one or more mobile cells are bound.
33. The method of any one of clauses 28 to 32, wherein sending comprises broadcasting the information.
34. A method for use in facilitating network connectivity of a wireless communication device in an Integrated Access and Backhaul, IAB, communication system including an IAB donor node managing a connection between the wireless communication device and a serving mobile cell serving the wireless communication device, the method at the IAB donor node comprising:
   sending, to the wireless communication device, information for identifying one or more other mobile cells as bound mobile cells to which the serving mobile cell is bound.
35. The method of clause 34, wherein the information sent to the wireless communication device includes at least one of:
   a group identifier for identifying a group of bound mobile cells associated with the one or more bound mobile cells to which the serving mobile cell is bound;
   a list of one or more identifiers of the one or more bound mobile cells to which the serving mobile cell is bound;
   a list of one or more identifiers of one or more mobile IAB nodes which are associated with the one or more bound mobile cells to which the serving mobile cell is bound;
   frequency information indicating the frequency for each bound mobile cell of some or all of the one or more bound mobile cells to which the serving mobile cell is bound.
36. The method of clause 34 or clause 35, further comprising:
   determining whether one or more new mobile cells are to be added as bound mobile cells and one or more mobile cells are to be removed as bound mobile cells,
   wherein sending comprises sending the information to the wireless communication device after determining at least one of one or more new mobile cells are to be added as bound mobile cells or one or more mobile cells are to be removed as bound mobile cells,
   wherein the information sent to the wireless communication device includes update information including at least one of information for identifying one or more new mobile cells which have added as bound mobile cells and information for identifying one or more mobile cells which have been removed as bound mobile cells.
37. The method of clause 36, wherein the update information includes at least one of:
   a list of one or more identifiers of the one or more new mobile cells added as bound mobile cells;
   a list of one or more identifiers of one or more mobile IAB nodes which are associated with the one or more new mobile cells added as bound mobile cells;
   a list of one or more identifiers of the one or more mobile cells removed as bound mobile cells;
   a list of one or more identifiers of one or more mobile IAB nodes which are associated with the one or more mobile cells removed as bound mobile cells.
38. The method of clause 34, further comprising:
   determining whether the serving mobile cell serving the wireless communication device is bound to one or more other mobile cells,
   wherein sending comprises sending the information to the wireless communication device after determining the serving mobile cell is bound to the one or more other mobile cells.
39. The method of clause 38, further comprising receiving configuration information for identifying one or more lists of mobile cells that are bound to each other and that are associated with one or more IAB nodes managed by the IAB donor node,
   wherein determining comprises determining whether the serving mobile cell serving the wireless communication device is bound to one or more other mobile cells based on the received configuration information.
40. The method of clause 39, wherein the configuration information is received from a core network entity or is received at factory set up.
41. The method of clause 39 or clause 40, wherein the configuration information includes at least one of:
   one or more group identifiers, each group identifier for identifying a group of bound mobile cells;
   for each group of bound mobile cells, a list of one or more identifiers of the one or more bound mobile cells in the group;
   for each group of bound mobile cells, a list of one or more identifiers of one or more mobile IAB nodes which are associated with the one or more bound mobile cells in the group.
42. A method for use in an Integrated Access and Backhaul, IAB, communication system including an IAB donor node, the method at the IAB donor node comprising:
   receiving configuration information for identifying one or more lists of mobile cells that are bound to each other and that are associated with one or more IAB nodes managed by the IAB donor node;
   sending, to at least one IAB node managed by the IAB donor node, information for identifying one or more bound mobile cells to which at least some of one or more mobile cells associated with the at least one IAB node are bound.
43. The method of clause 42, wherein the configuration information is received from a core network entity or is received at factory set up.
44. The method of clause 42 or clause 43, wherein the configuration information includes at least one of:
   one or more group identifiers, each group identifier for identifying a group of bound mobile cells;
   for each group of bound mobile cells, a list of one or more identifiers of the one or more bound mobile cells in the group;
   for each group of bound mobile cells, a list of one or more identifiers of one or more mobile IAB nodes which are associated with the one or more bound mobile cells in the group.
45. The method of any one of clauses 42 to 44, wherein the information sent to the at least one IAB node managed by the IAB donor node includes for each IAB node at least one of:
   one or more group identifiers, each group identifier for identifying a group of bound mobile cells that include at least one mobile cell associated with the IAB node;
   for each group of bound mobile cells that include at least one mobile cell associated with the IAB node, a list of one or more identifiers of the one or more bound mobile cells in the group;
   for each group of bound mobile cells that include at least one mobile cell associated with the IAB node, a list of one or more identifiers of one or more mobile IAB nodes which are associated with the one or more bound mobile cells in the group;
   for each group of bound mobile cells that include at least one mobile cell associated with the IAB node, frequency information indicating the frequency for each bound mobile cell of some or all of the one or more bound mobile cells in the group;
   for each group of bound mobile cells that include at least one mobile cell associated with the IAB node, frequency information indicating the frequency for each bound mobile cell of some or all of the one or more bound mobile cells in the group.
46. A method for use in facilitating network connectivity of a wireless communication device in an Integrated Access and Backhaul, IAB, communication system including an IAB donor node, the method at the IAB donor node comprising:
   receiving, from a wireless communication device, a request for setting up a connection with a mobile cell associated with an IAB node managed by the IAB donor node;
   in the case where the mobile cell requested for connection is bound to one or more other mobile cells, sending, to the wireless communication device, information for identifying one or more other mobile cells as bound mobile cells to which the mobile cell requested for connection is bound.
47. The method of clause 46, wherein the information includes at least one of:
   a group identifier for identifying a group of bound mobile cells associated with the one or more bound mobile cells to which the mobile cell requested for connection is bound;
   a list of one or more identifiers of the one or more bound mobile cells to which the mobile cell requested for connection is bound;
   a list of one or more identifiers of one or more mobile IAB nodes which are associated with the one or more bound mobile cells to which the mobile cell requested for connection is bound;
   frequency information indicating the frequency for each bound mobile cell of some or all of the one or more bound mobile cells to which the mobile cell requested for connection is bound.
48. The method of clause 46 or clause 47, further comprising: determining whether the mobile cell requested for connection is bound to one or more other mobile cells.
49. The method of clause 48, further comprising receiving configuration information for identifying one or more lists of mobile cells that are bound to each other and that are associated with one or more IAB nodes managed by the IAB donor node,
   wherein determining comprises determining whether the mobile cell requested for connection is bound to one or more other mobile cells based on the received configuration information.
50. The method of clause 49, wherein the configuration information is received from a core network entity or is received at factory set up.
51. The method of clause 49 or clause 50, wherein the configuration information includes at least one of:
   one or more group identifiers, each group identifier for identifying a group of bound mobile cells;
   for each group of bound mobile cells, a list of one or more identifiers of the one or more bound mobile cells in the group;
   for each group of bound mobile cells, a list of one or more identifiers of one or more mobile IAB nodes which are associated with the one or more bound mobile cells in the group.
52. The method of any one of clauses 46 to clause 51, further comprising:
   in the case the IAB donor node determines the mobile cell requested for connection is bound to one or more other mobile cells, negotiating Conditional Handover, CHO, with one or more IAB nodes, the one or more IAB nodes being associated with at least some of the one or more other mobile cells;
   sending, to the wireless communication device, configuration information for CHO for the at least some of the one or more other mobile cells based on the negotiation.
53. The method of clause 52, wherein negotiating CHO comprises:
   sending, to each of the one or more IAB nodes, a setup request for requesting CHO to the respective IAB node;
   receiving, from at least one of the one or more IAB nodes, a setup response acknowledging receipt of the setup request.
54. The method of any one of clauses 46 to clause 53, further comprising:
   in the case the IAB donor node determines the mobile cell requested for connection is bound to one or more other mobile cells and at least one IAB node associated with at least some of the one or more other mobile cells is managed by another IAB donor node, negotiating Conditional Handover, CHO, with the another IAB donor node;
   sending, to the wireless communication device, configuration information for CHO for the at least some of the one or more other mobile cells associated with the at least one IAB node managed by the another IAB donor node based on the negotiation.
55. The method of clause 54, wherein negotiating CHO comprises:
   sending, to the another IAB donor node managing the at least one IAB node, a setup request for requesting CHO to the at least one IAB node;
   receiving, from the another IAB donor node, a setup response acknowledging receipt of the setup request.
56. The method of clause 53 or clause 55, wherein the setup request sent includes information relating to the wireless communication device for creating a context for the wireless communication device at the respective IAB node.
57. The method of any one of the preceding clauses, wherein a cell is bound to a mobile cell when movement of the cell is related to movement of the mobile cell.
58. The method of any one of the preceding clauses, wherein the wireless communication device is User Equipment, UE, or a mobile IAB node.
59. An apparatus for a wireless communication device, the apparatus comprising:
   one or more processing units configured to perform the method as recited in any one of clauses 1 to 27, clause 57 or clause 58.
60. An apparatus for an Integrated Access Backhaul, IAB, node of an IAB communication system, the apparatus comprising:
   one or more processing units configured to perform the method as recited in any one of clauses 28 to 33, clause 57 or clause 58.
61. An apparatus for an Integrated Access Backhaul, IAB, donor node of an IAB communication system, the apparatus comprising:
   one or more processing units configured to perform the method as recited in any one of clauses 34 to 58.
62. A computer program comprising instructions which, when the program is executed by a computer, cause the computer to carry out the method according to any one of clauses 1 to 58.
63. A computer-readable medium carrying a computer program according to clause 62.

1. A method, performed at a User Equipment, UE, for use in facilitating network connectivity of the UE in an Integrated Access and Backhaul, IAB, communication system, comprising:
receiving information for identifying a plurality of mobile IAB cells;
in a case where the UE is on a vehicle, determining whether there are one or more mobile IAB cells amongst neighbouring cells of the UE based on the received information, wherein the information includes a list of identifiers of the plurality of mobile cells.

2-5. (canceled)

6. The method of claim 1, wherein the information for identifying a plurality of mobile IAB cells further includes:
frequency information indicating the frequency for each mobile cell of some or all of the plurality of mobile cells.

7-9. (canceled)

10. The method of claim 1, wherein the list of identifiers includes a list or a range of Physical Cell Identities, PCIs.

11-18. (canceled)

19. The method of claim 1, further comprising:
in a case where the UE is on a vehicle with a mobile IAB cell, the mobile IAB cell serving the UE, and in a case where the UE is in a RRC non-connected state, determining a need for cell reselection;
after determining a need for cell reselection, determining whether at least one neighbouring cell of one or more neighbouring cells discovered by the UE is a mobile IAB cell;
after determining at least one neighbouring cell is a mobile IAB cell, performing cell reselection to the mobile IAB cell.

20-62. (canceled)

63. An apparatus for a User Equipment, UE, the apparatus comprising:
one or more processing units configured to:
receive information for identifying a plurality of mobile IAB cells;
in a case where the UE is on a vehicle, determine whether there are one or more mobile IAB cells amongst neighbouring cells of the UE based on the received information,
wherein the information includes a list of identifiers of the plurality of mobile cells.

64-66. (canceled)

67. A non-transitory computer-readable storage medium carrying a computer program comprising instructions which, when the program is executed by one or more processing units of a User Equipment, UE, cause the one or more processing units to:
receive information for identifying a plurality of mobile IAB cells;
in a case where the UE is on a vehicle, determine whether there are one or more mobile IAB cells amongst neighbouring cells of the UE based on the received information,
wherein the information includes a list of identifiers of the plurality of mobile cells.

68. The method of claim 1, further including receiving, from a cell, a mobility indication for indicating the cell is a mobile IAB cell.

69. The method of claim 68, wherein receiving, from a cell, includes receiving, from a cell, a SIB1 message including the mobility indication.

70. The method of claim 1, wherein receiving information includes receiving a SIB4 message including the information for identifying a plurality of mobile IAB cells.

71. The method of claim 1, further comprising after determining there are one or more mobile IAB cells amongst neighbouring cells, performing a connection process to one of the one or more mobile IAB cells in preference to other neighbouring cells of the UE.

72. The method of claim 1, further comprising after determining there are one or more mobile IAB cells amongst neighbouring cells, keeping a connection with one of the one or more mobile IAB cells in preference to other neighbouring cells of the UE.

73. The method of claim 1, wherein determining includes in the case where the UE is on a vehicle with a mobile IAB cell, the mobile IAB cell serving the UE, determining whether there are one or more other mobile IAB cells amongst neighbouring cells of the UE based on the received information,
wherein the method further comprises after determining there are one or more other mobile IAB cells amongst neighbouring cells, performing cell reselection to one of the one or more other mobile IAB cells in preference to other neighbouring cells of the UE.

74. The method of claim 1, wherein receiving comprises receiving, from an IAB node, the information for identifying a plurality of mobile IAB cells.

75. The method of claim 1, further comprising after determining there are one or more mobile IAB cells amongst neighbouring cells, performing a connection process or keeping a connection with one mobile IAB cell of the one or more mobile IAB cells in preference to other neighbouring cells of the UE, the one mobile IAB cell being a mobile IAB cell associated with an IAB node on the vehicle.

76. The apparatus of claim 63, wherein the one or more processing units are configured to receive, from a cell, a mobility indication for indicating the cell is a mobile IAB cell.

77. The apparatus of claim 63, wherein the one or more processing units are configured to receive, from a cell, a SIB1 message including a mobility indication for indicating the cell is a mobile IAB cell.

78. The apparatus of claim 63, wherein the one or more processing units are configured to receive information by receiving a SIB4 message including the information for identifying a plurality of mobile IAB cells.

79. The apparatus of claim 63, wherein the one or more processing units are configured to: after determining there are one or more mobile IAB cells amongst neighbouring cells, perform a connection process to one of the one or more mobile IAB cells in preference to other neighbouring cells of the UE.

80. The apparatus of claim 63, wherein the one or more processing units are configured to determine whether there are one or more other mobile IAB cells amongst neighbouring cells of the UE based on the received information in the case where the UE is on a vehicle with a mobile IAB cell, the mobile IAB cell serving the UE,
wherein the one or more processing units are configured to: after determining there are one or more other mobile IAB cells amongst neighbouring cells, perform cell reselection to one of the one or more other mobile IAB cells in preference to other neighbouring cells of the UE.

81. The apparatus of claim 63, wherein the one or more processing units are configured to receive information by receiving, from an IAB node, the information for identifying a plurality of mobile IAB cells.

82. The apparatus of claim 63, wherein the information for identifying a plurality of mobile IAB cells further includes:
frequency information indicating the frequency for each mobile cell of some or all of the plurality of mobile cells.
